(19) United States
(12) Patent Application Publication
(10) Pub. No.: US 2006/0198507 A1
(43) Pub. Date: Sep. 7, 2006

(54) RESOURCE ALLOCATION METHOD FOR NETWORK AREA AND ALLOCATION PROGRAM THEREFOR, AND NETWORK SYSTEM

(75) Inventors: Takeshi ISHIDA, Tokyo (JP); Minoru Yamamoto, Tokyo (JP); Taku Kamada, Tokyo (JP); Nobuhiko Fukui, Tokyo (JP)

Correspondence Address: STAAS & HALSEY LLP;JIM LIVINGSTON, SUITE 700, 1201 NEW YORK AVENUE, N.W., WASHINGTON, DC, 20005, US

(73) Assignee: FUJITSU LIMITED, Kawasaki (JP)

(21) Appl. No.: 11/276,436

(22) Filed: Feb. 28, 2006

Related U.S. Application Data
(63) Continuation-in-part of application No. 11/239,070, filed on Sep. 30, 2005.

(30) Foreign Application Priority Data
Feb. 28, 2005 (JP) 2005-054681
Feb. 7, 2006 (JP) 2006-030345

(51) Int. Cl. H04M 7/00

(52) U.S. Cl. 379/221.09

(57) ABSTRACT

A node resource within its own area is allocated to a service in accordance with a quality of service to be provided, a node resource lent out to adifferent network area is cancelled to allocate the lent out node resource to the service when there is a shortage of node resource, and further a node resource is borrowed from a different network area to allocate the borrowed node resource to the service when there still is a shortage of node resource.

### CROSS-REFERENCE TO RELATED APPLICATIONS

This patent application is a continuation in part application of the previous U.S. patent application, titled “Resource Allocation Method for Network Area and Allocation Program therefor, and Network System”, filed on Sep. 30, 2005, application Ser. No. 11/239,070, herein incorporated by reference.

### BACKGROUND OF THE INVENTION

1. Field of the Invention

The present invention relates to a resource allocation method for a network area comprising a plurality of nodes, more particularly to the resource allocation method, for a network area, capable of allocating autonomously a resource existing outside the domain of the network by borrowing a node resource existing in a different network area and allocating the borrowed node resource to a service when a service to be provided requires more node resource than what is available within its own network.

2. Description of the Related Art

A conventional method for operating a plurality of distributed processing systems sharing a resource provided through a network have been widely used, in which an observed problem is that, if the configuration is statically structured, it is very difficult to respond to unevenly distributed requests, causing uneven load on a certain server and hence making difficult to maintain a quality of service.

Another problem has been, in configuring a distributed system, that the development of service requires a consideration of the distributed system from the beginning, causing a cost increase in proportion with the range of distribution and accordingly a difficulty of such system development. Furthermore, if the system setup needs to be changed, the setup of each node constituting the system has to be modified individually, causing not only the cost therefor, but also a possibility of incomplete modification.

In some distributed systems operating on a network, a dynamic resource allocation is done in response to the usage condition or the resource states, in which system, however, an observed problem is that it is difficult to maintain a required quality of service when there is a sudden increase in requests for processing, since the resource reallocation is limited to the resources within a specific network only if there is a shortage of resource for a certain processing.

Reference documents are available for resource allocation methods in such distributed processing systems as follows.

[Patent document 1] Japanese patent laid-open application publication No. 5-235948; “Service Node Proliferation Method”

[Patent document 2] Japanese patent laid-open application publication No. 8-137811; “Network Resource Allocation Change Method”

[Patent document 3] Japanese patent laid-open application publication No. 2002-251344; “Service Management Apparatus”

The patent document 1 discloses a technique that, when processing-busy processing means receives a service request packet, the processing means adds the station address for a proliferated service node to the aforementioned service request packet and transmits the packet to the transmission path so as to ask the service requester to make the service request to the proliferated service node anew.

The patent document 2 discloses a technique in which a node, having received a request from each processing module for resource allocation, determines how much resource to be allocated to applicable processing module in consideration of imposing load on its own node and requests another node for allocating new resource, thereby leveling loads and allocating resources efficiently.

The patent document 3 discloses a service management method, that has to do with accomplishing an SLA (Service Level Agreement) for assuring a quality of application provision service for a client, in which the service servers are grouped into a plurality of levels in accordance with the quality of service to be provided and an intermediate server is furnished to make the quality of providing service variable so as to use the intermediate server for a group when the load on one of the groups becomes large, thereby maintaining the quality of service while keeping the load on each group even.

In these conventional techniques, however, a change in allocating resources is done within a closed network and therefore has not been able solve the problem of non-uniform quality of service when there is a shortage of resource within the closed network.

### SUMMARY OF THE INVENTION

In consideration of the above described problems, the challenge of the present invention is to enable a quality of service to be maintained dynamically by allocating a resource autonomously in cooperation with other network area when there is a shortage of node resource within a network area in order to fulfill the quality of service to be provided within its own network area comprising a plurality of nodes.

A resource allocation method according to the present invention, being used in a network area comprising a plurality of nodes, allocates a node resource within the own network area to a service in response to a quality of service to be provided in the network area and, when there is a shortage of node resource within the own network area, borrow a node resource from a network area different from its own network area to allocate the borrowed node resource to the aforementioned service.

### BRIEF DESCRIPTION OF THE DRAWINGS

FIG. 1 is a fundamental functional block diagram of a resource allocation method according to the present invention;

FIG. 2 describes a basis of autonomous network system operation method according to the present invention;

FIG. 3 shows a physical comprisal of node according to the present embodiment;

FIG. 4 shows a structure of program deployed in the memory of each node;

FIG. 5 shows an overall configuration of system comprising nodes;

FIG. 6 describes a list of terminologies relating to an overall system configuration;

FIG. 7 describes an example of forming groups;

FIG. 8 describes a quantification of node capability;

FIG. 9 describes a summary of creating an operation schedule;

FIG. 10 describes how node power is lent out across areas according to a first embodiment;

FIG. 11 shows a logical structural block diagram of common node;

FIG. 12 shows a logical structural block diagram of service management node;

FIG. 13 shows a logical structural block diagram of area management node;

FIG. 14 shows information retained by each data base within a node (part 1);

FIG. 15 shows information retained by each data base within a node (part 2);

FIG. 16 shows an overall cycle of system operation;

FIG. 17 shows a time series chart ranging from making an operation schedule to the system operation;

FIG. 18 is an overall flow chart of system operation;

FIG. 19 shows a detail sequence of system startup;

FIG. 20 shows a detail sequence of system startup (continued from the above);

FIG. 21 is an overall sequence relation chart for creating an operation schedule;

FIG. 22 describes a logic of creating operation schedule;

FIG. 23 shows an example of node power allocation plan for each service;

FIG. 24 shows a detail sequence of creating an operation schedule;

FIG. 25 shows a detail sequence of creating an operation schedule (continued from the above);

FIG. 26 describes contents of exchanged data within a sequence;

FIG. 27 describes a calculation logic of node power required for an application;

FIG. 28 shows a detail sequence of schedule merging;

FIG. 29 shows a detail sequence of requesting other area for borrowing power;

FIG. 30 shows a detail sequence of requesting other area for borrowing power (continued from the above −1);

FIG. 31 shows a detail sequence of requesting other area for borrowing power (continued from the above −2);

FIG. 32 shows a detail flow chart of how a capability of lending node power to other area is judged;

FIG. 33 shows a detail sequence chart for notifying a lending stop to other area;

FIG. 34 describes a time series chart including a sequence for creating an operation schedule in association with a lending stop notification;

FIG. 35 shows a detail flow chart of node power borrowing period renewal request processing;

FIG. 36 shows a detail sequence for executing a quality prediction;

FIG. 37 shows a detail sequence for executing a quality prediction (continued from the above);

FIG. 38 shows a detail sequence for proposing to an operations manager;

FIG. 39 shows a detail sequence for proposing to an operations manager (continued from the above);

FIG. 40 shows an overall relation chart of grouping sequence;

FIG. 41 shows a detail sequence for allocating an actual node;

FIG. 42 shows a detail sequence for notifying a power lending area;

FIG. 43 shows a detail sequence for notifying a power lending area (continued from the above);

FIG. 44 shows a detail sequence for notifying a service management node;

FIG. 45 shows a detail sequence for allocating a module to a power lending area;

FIG. 46 shows a detail sequence for allocating a module to a power lending area (continued from the above);

FIG. 47 shows a detail sequence for allocating a module to a common node;

FIG. 48 shows a detail sequence for allocating a module to a common node (continued from the above −1);

FIG. 49 shows a detail sequence for allocating a module to a common node (continued from the above −2);

FIG. 50 shows a detail sequence for executing application by a common node;

FIG. 51 shows a detail sequence for executing application by a power borrowing node;

FIG. 52A and 52B show an overall sequence relation chart for collecting and checking operational information;

FIG. 53 shows a detail sequence for obtaining operational information and normalizing the data;

FIG. 54 shows a detail sequence for checking quality;

FIG. 55 shows a detail sequence for checking quality (continued from the above −1);

FIG. 56 shows a detail sequence for checking quality (continued from the above −2);

FIG. 57 shows a detail sequence for submitting operational information to a service management node;

FIG. 58 describes a node power lending-out system across areas according to a second embodiment;

FIG. 59 shows a detail sequence of requesting for borrowing power according to the second embodiment;

FIG. 60 shows a detail sequence of requesting for borrowing power (continued from the above −1) according to the second embodiment;

FIG. 61 shows a detail sequence of requesting for borrowing power (continued from the above −2) according to the second embodiment;

FIG. 62 shows a detail sequence chart for notifying a lending stop according to the second embodiment;

FIG. 63 shows a detail sequence chart for notifying a lending stop (continued from the above) according to the second embodiment;

FIG. 64 shows an overall relation chart of grouping sequence according to the second embodiment;

FIG. 65 shows a detail sequence chart for notifying a root management node relating to FIG. 64;

FIG. 66 shows a detail sequence for notifying a power lending area according to the second embodiment;

FIG. 67 shows a detail sequence for notifying a power lending area (continued from the above) according to the second embodiment;

FIG. 68 shows a detail sequence for notifying information on a surrogate service management node according to the second embodiment;

FIG. 69 shows a detail sequence for notifying information on a surrogate service management node (continued from the above) according to the second embodiment; and

FIG. 70 describes a computer loading of program according to the present embodiment.

### DESCRIPTION OF THE PREFERRED EMBODIMENTS

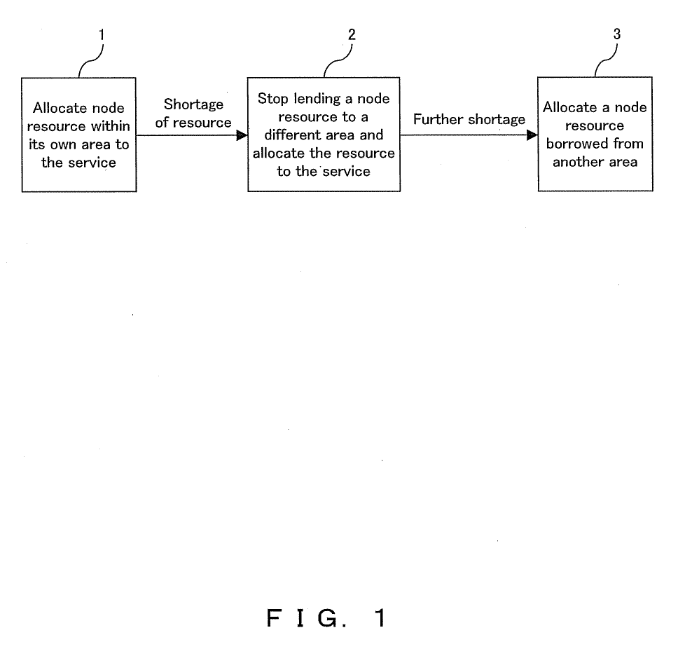

FIG. 1 is a fundamental functional block diagram of a resource allocation method in a network area according to the present invention. FIG. 1 is a fundamental functional block diagram of a resource allocation method in a network area which comprises a plurality of nodes.

As shown by FIG. 1, first, the step 1 is to allocate a node resource within its own network area to a service in response to the quality of the service to be provided within the network area and, if there is a shortage of node resource within its own network, the step 2 is to stop lending out a node resource to the other network area to allocate the lent out node resource to the service, and, if there is still a shortage of node resource, then the step 3 is to borrow a node resource from a different network area to allocate the borrowed node resource to the service.

If there is no node resource being lent out to other network area, and if there is a shortage of node resource after allocating the node resources within its own network area to the service in the step 1, then the step 3 is to borrow a node resource from a different network area to allocate the borrowed node resource to the service according to the present invention.

A resource allocation program according to the present invention is a program for making a computer execute the above described resource allocation method, and a storage media comprehends a computer readable portable storage medium storing such a program.

Furthermore, a network system according to the present invention, which is applicable to one network area comprising a plurality of nodes, comprises a common node for executing an application constituting a service to be provided within the network area and an area management node for allocating a common node resource within its own network area to the service in response to the quality of the service and borrowing a common node resource from a different network area if there is a shortage of node resource within its own network area to allocate the borrowed node resource to the service.

As described above, if there is a shortage of node resource within the own network area, the present invention is to borrow a node resource from a different network area autonomously to allocate the borrowed node resource to the service.

The present invention makes it possible to renew an allocation of node for executing an application, that is, a server, autonomously in response to the transition of requests associated with the application constituting a service and maintain the service level effectively by cooperating with another network area if the node resource within its own network becomes in short supply, hence the present invention contributes to an accomplishment of service level agreement in great deal.

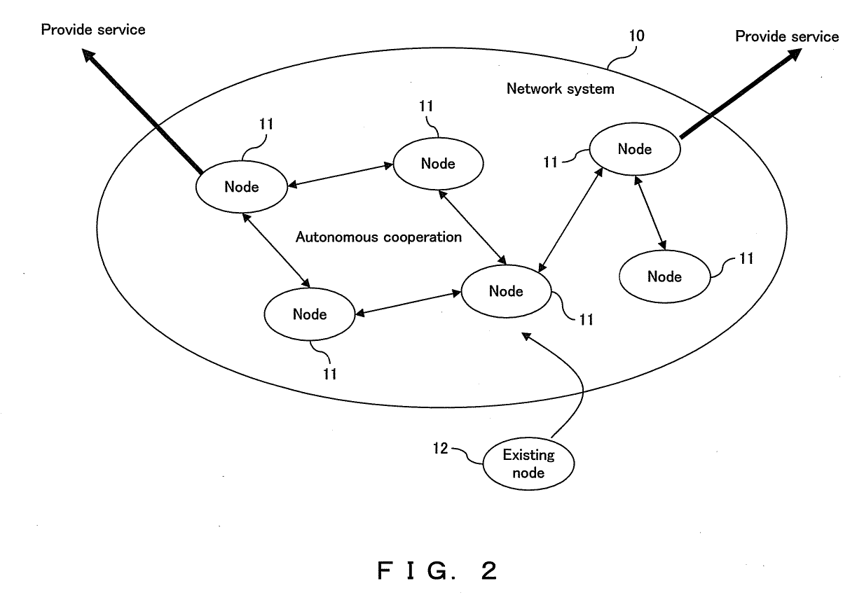

FIG. 2 describes the basic configuration of network system according to the present invention. In FIG. 2, the network system 10 (simply “system” sometimes hereinafter), comprising a plurality of nodes 11, is fundamentally characterized as the nodes forming a group by cooperating with one another autonomously, changing the configuration of the group in response to the state in order to maintain the quality of service for each applicable group and providing a service externally at the specified quality thereof. Note that the service is generally constituted by a plurality of applications which are executed by nodes that are called common nodes as described later and the service is operated so as to maintain at a specified quality.

The present embodiment monitors the operational states of the system 10 in real time and the operational information for each service so as to create an operational schedule for the service in order to maintain the specified quality for the service to be provided in accordance with the result of collecting the operational information and accordingly forming the groups for each service.

In other words, three sequences, i.e., collecting operational information, creating an operational schedule and grouping for each service, are autonomously repeated as the operation to maintain a quality of service in response to the operational condition of the system. An autonomous collection and analysis of operational information make it possible to suppress an external management cost to a minimum.

Each node 11 constituting the system 10 is not fixed, but can be converted from an existing node 12 belonging to other conventional system by adding the function required by the present embodiment in order to become a part of the system 10, thus adding further flexibility to change the system configuration in response to a status such as a request to the service.

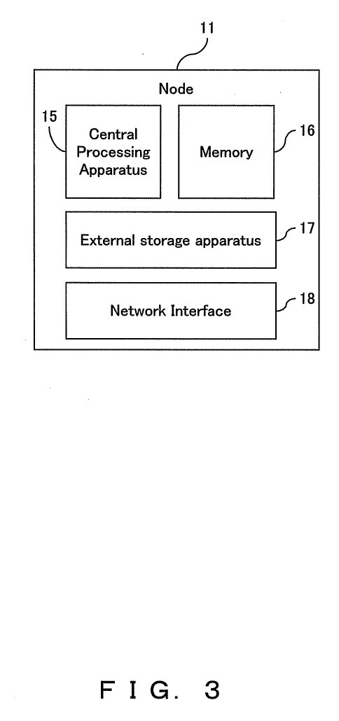

FIG. 3 shows a physical comprisal of node according to the present embodiment. The node 11 generally comprises a central processing apparatus 15, a memory 16, an external storage apparatus 17 and a network interface 18.

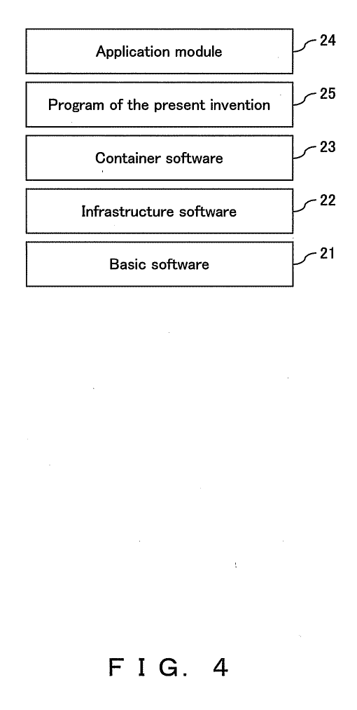

FIG. 4 shows a structure of program deployed in a virtual region inside the memory 16 or external storage apparatus 17 of each node shown by FIG. 3. In FIG. 4, basic software 21 comprehends an operating system for example, infrastructure software 22 comprehends the Java virtual machine for example, and container software 23 comprehends basic software for driving an application such as an application server for example. A program 25 according to the present invention is for executing the processing to repeat the above described three sequences, i.e., collecting operational information, creating an operational schedule and grouping for each service, according to the present embodiment, while performing an intermediary processing between the application module 24 and the container software 23.

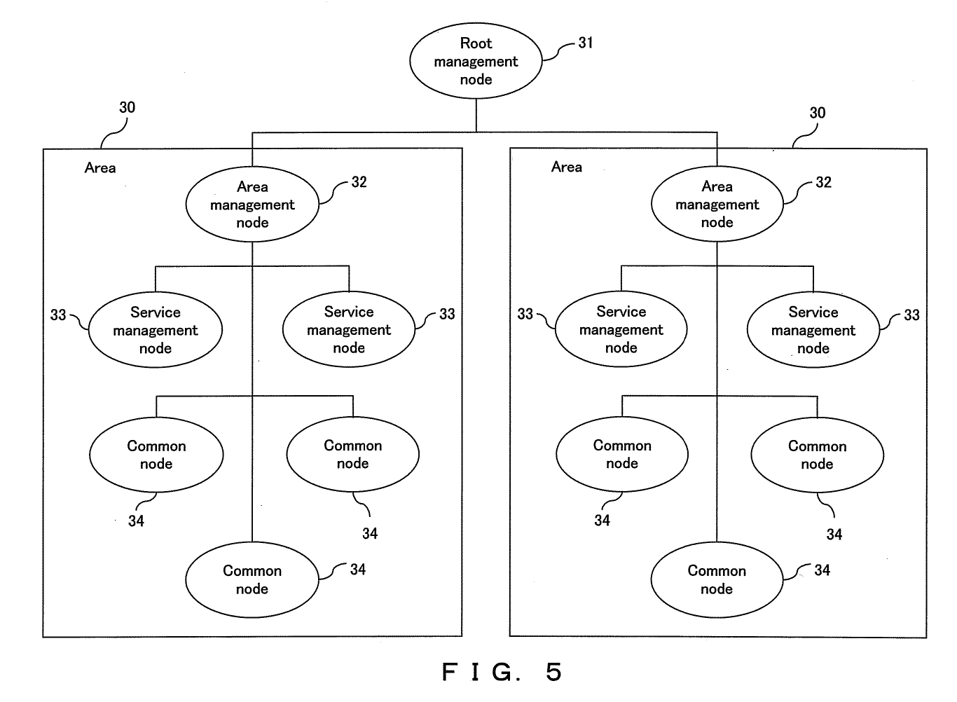

FIG. 5 shows an overall configuration of the system. In FIG. 5, the system comprises a plurality of areas 30 and a root management node 31 as the node for managing across all areas, with the area 30 having a hierarchical structure containing an area management node 32 on the top layer, service management nodes 33 in the middle layer and common nodes 34 on the bottom layer.

That is, the area 30 comprises the area management node 32 for managing all nodes within the area, the service management nodes 33 for managing so as to take responsibility of the quality of assigned service and the common nodes 34 for executing applications constituting a service in compliance to an instruction from the service management node 33. The common node 34 is configured not to have an application that constitutes a service at the initial state and to execute an application module allocated by the service management node 33 as required basis.

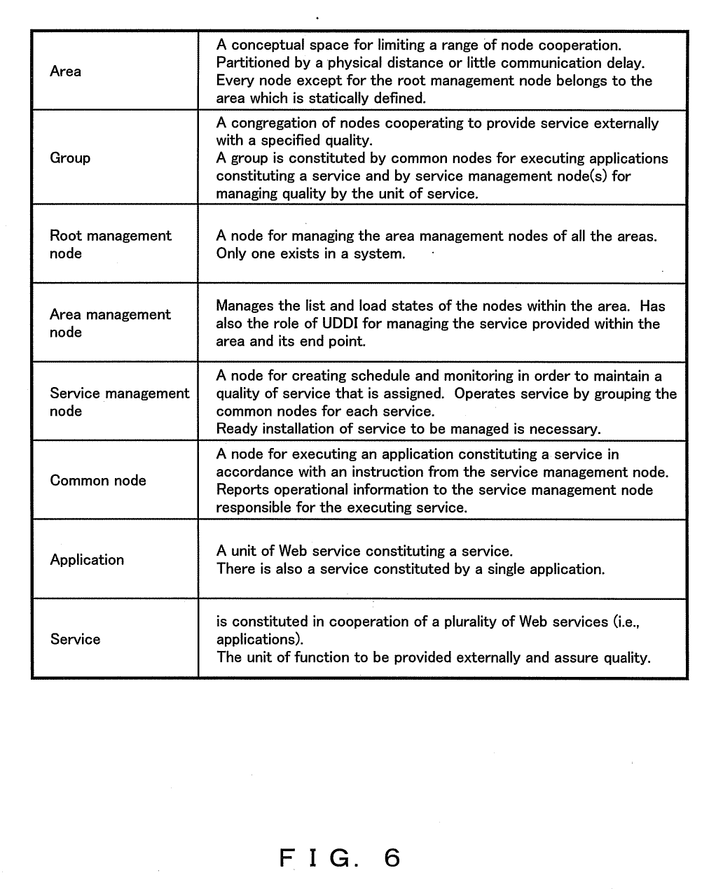

FIG. 6 describes a list of terminologies relating to an overall system configuration. In FIG. 6, an “area” is partitioned by either a physical distance or a zone with small communication delay, and a “group”, as a congregation for providing service within an area, generally comprises a plurality of common nodes and service management nodes. Partitioning of area will be left with the discretion of the system operator. The partitioning area can also be Kanagawa Region, Chiba Region and the North America Region for example.

Only one “root management node” exists in a system and has a role of showing what service is being provided in a particular area as the UDDI (Universal Description Discovery and Integration). An “area management node” has also a role of the UDDI for managing the service within the area and the end point. An application is assumed to be readily installed by a “service management node” constituting the service to be managed thereby. A “common node” reports the operational information to the service management node which is responsible for the service constituted by the application to execute.

And an “application” constitutes a service such as a unit of Web service, and a “service” is configured in a form of cooperating with a plurality of Web services as a unit of function being provided to the outside and supposed to assure quality.

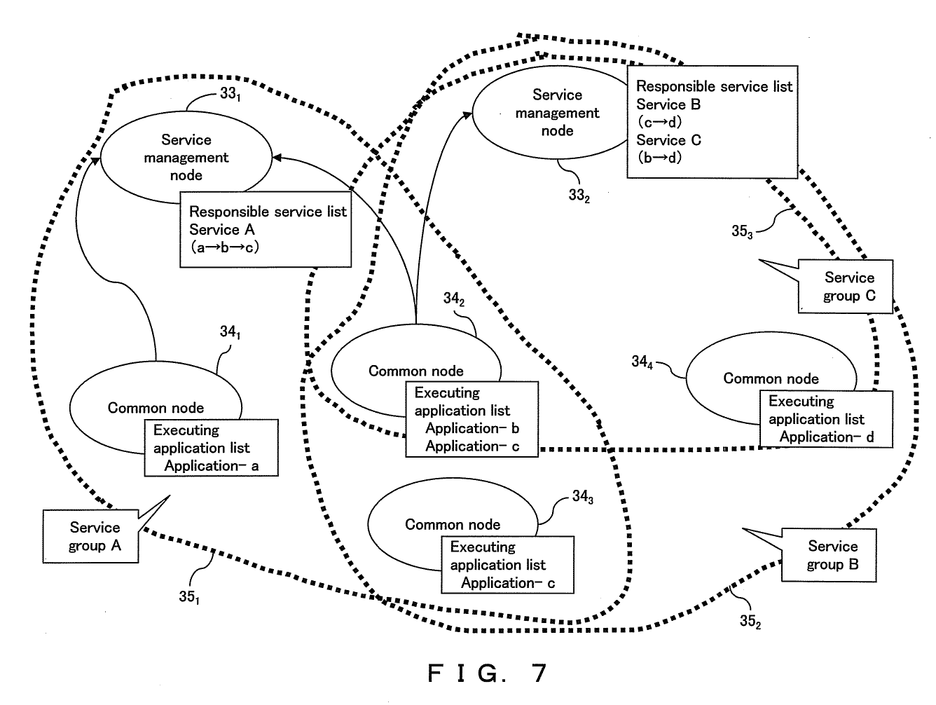

FIG. 7 describes an example of forming groups. In FIG. 7, a service A is managed by a service management node 33₁, and a service group A 35₁ further comprises three common nodes 34₁, 34₂ and 34₃. The service A is provided by executing three applications a, b and c in this sequence for example. The common node 34₁ executes the application—a, and reports the operational information as a result of the execution to the service management node 33₁ that manages the service group A 35₁ which the common node 34₁ belongs to, for example. If a common node belongs to a plurality of services in association with the node executing a certain application, the node reports the operational information to the service management nodes that manage the respective groups with reports relating to the respective services.

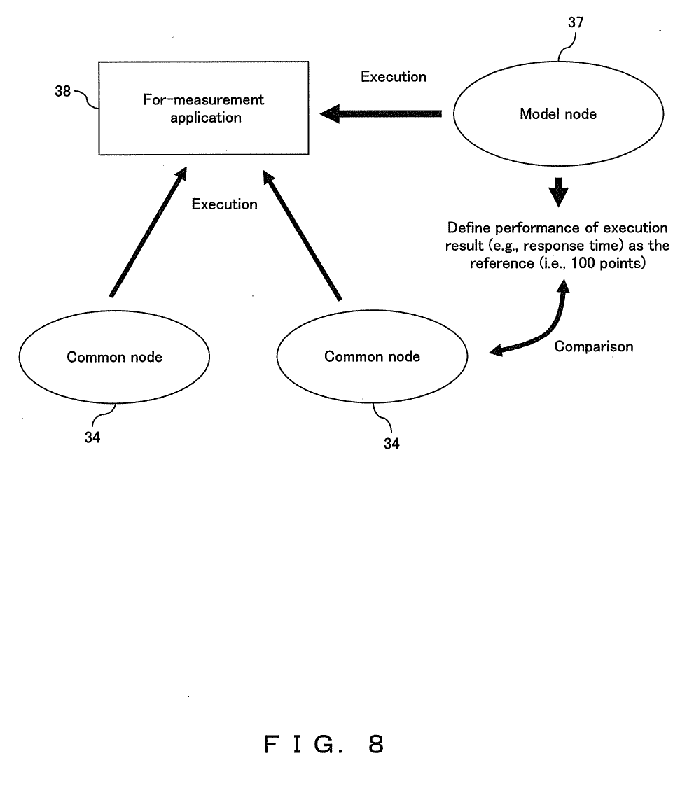

In the present embodiment, a service management is performed by quantifying the capability of the common node which executes an application. FIG. 8 describes a quantification of node capability. As shown by FIG. 8, a commonly specified node is picked up as a model node for reference node capability; the performance of the model node 37 as a result of executing an for-measurement application 38, such as the average response time to certain requests, is defined to be 100 points as the reference; the performance of a common node 34, such as the average response time as a result of executing a for-measurement application 38, is compared with the aforementioned reference; and the applicable node power is quantified by the ratio of performance to the reference. The node power of the common node 34 is measured in advance and stored in a later described operational setting definition body.

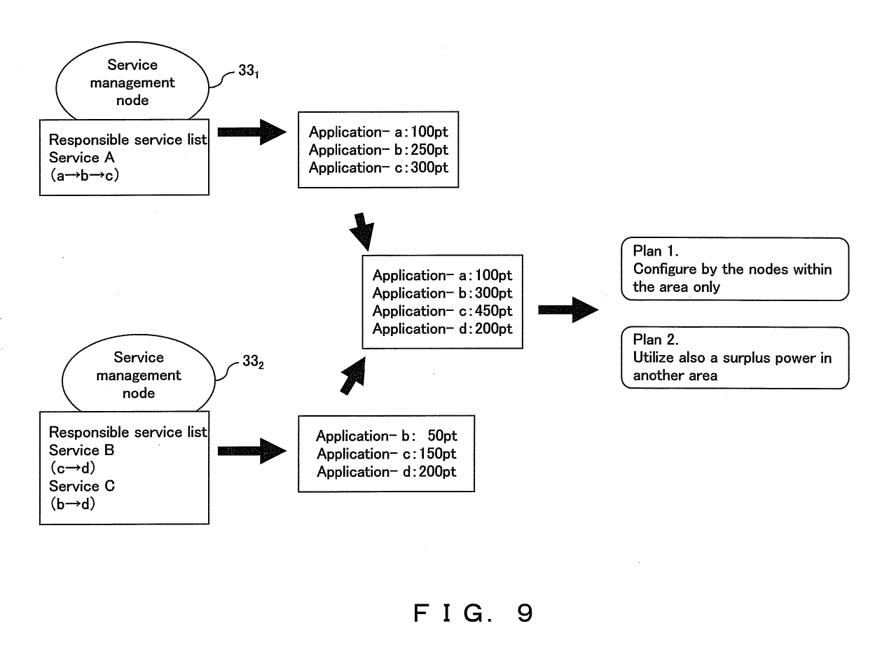

FIG. 9 describes an operational schedule creation method. In FIG. 9, let it define that the service management node 331 manages the service A, and the service management node 332 manages the services B and C. The service A is configured by three applications-a, -b and -c; the service B by two applications-c and -d; the service C by two applications-b and -d. The service management node 33₁ calculates a node capability required for providing the responsible service A, that is, node power for each application as the point number described in association with FIG. 8; and the service management node 33₂ likewise calculates node powers as the point numbers for three applications required for providing the responsible services B and C.

As described later, the area management node merges the schedules created by all service management nodes within the area, calculates the sum of node power required within the area, and creates a schedule for operating the respective services. In the process of creating the schedule, the area management node does not necessarily create a single schedule, but the schedules by a plurality of patterns, such as which service to run with a shortage of node power, especially when there is a shortage thereof.

For instance, if all the service can be scheduled by the node power of common nodes within the area, a schedule is created for the service configured by the nodes within the area only as shown by the plan 1, whereas if there is a shortage of power in the common nodes within the area, a schedule is created by utilizing a surplus node power in another area as shown by the plan 2, in which case the area management node searches for a surplus node power possessed by an adjacent area by way of the area management node of the adjacent area for instance and creates a schedule with an assumption to borrow the node power of that area if possible. If schedules by a plurality of patterns are created, an operations manager of the system for example gives instructions for a schedule selection or necessary modification.

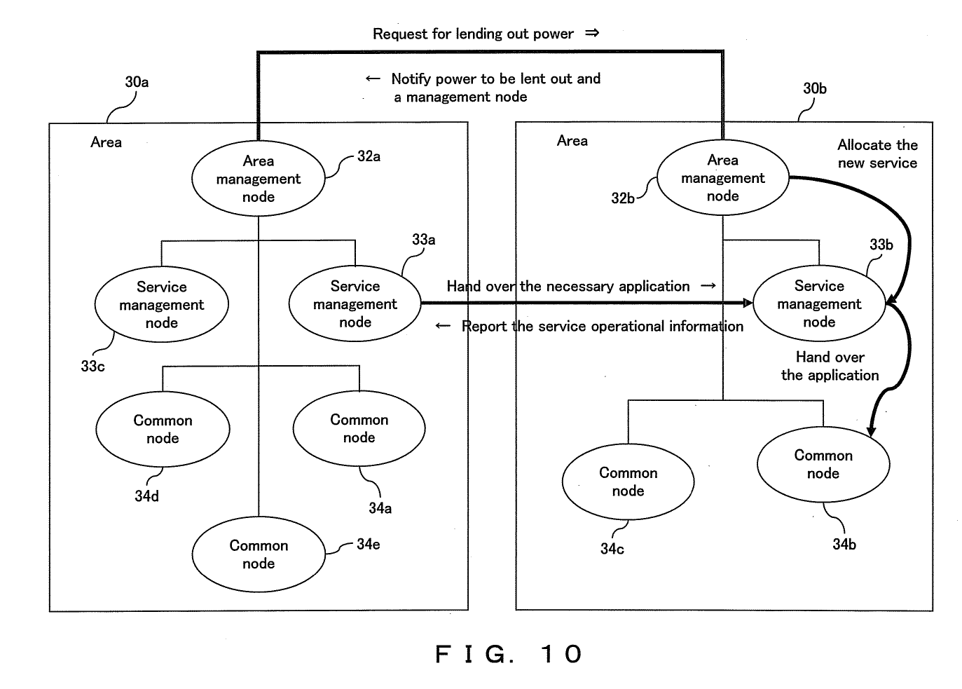

FIG. 10 describes how node power is lent out across the areas according to a first embodiment. For instance, if there is a shortage of node power in creating a schedule for the area 30a, the area management node 32a requests the area management node 32b which manages the other area 30b for lending node power. Upon receiving the request, the area management node 32b investigates whether or not it is possible to lend out node power possessed by its own area and, if it is possible, notifies the possible node power to be lent out and introduces to the service management node which manages the common node having the applicable node power.

If it is possible to lend out node power, the area management node 32b allocates the new service to the service management node 33b which manages a common node having a surplus node power 34b, for example, while the service management node 33a which manages the service within the node borrowing area 30a transmits the necessary application module, et cetera, to the service management node 33b which in turn sends the application module to a common node 34b, followed by the common node 34b reporting the execution result of the application, that is, the service operational information, back to the service management node 33a, by way of the service management node 33b, of the area 30a which has borrowed the node power.

Comparably with the above, a later described second embodiment is configured to carry out a lending of node power across areas by an intervention of a root management node in lieu of between area management nodes. That is, the second embodiment is configured in such a manner that the area management node of each area reports a state of spare node power of the own area to the root management node at the end of forming a group associated with a system operation schedule planning for each area as described later.

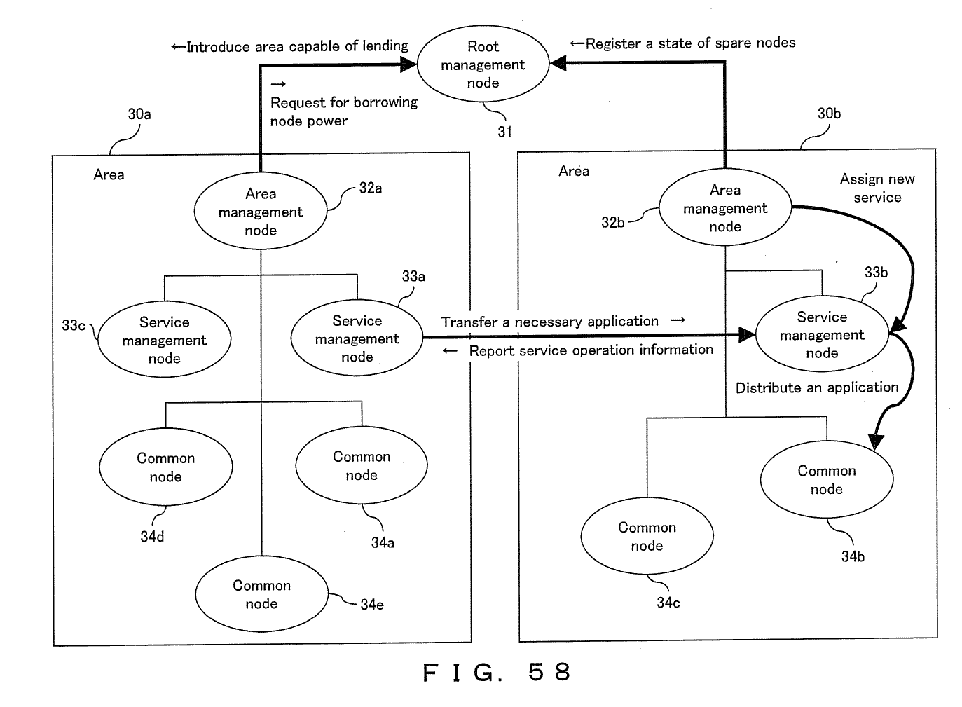

And the area management node of the area wanting to borrow node power sends an inquiry to the root management node asking for an area capable of lending out the node power so that the root management node introduces an area capable of lending out corresponding to a state of spare node power available in each area. Note, however, that the root management node is not disposed for intervening in an actual service implementation preparation, e.g., a distribution of an application module, a report on the service implementation information, et cetera, the details of which are described by using FIGS. 58 through 69 following a description of the first embodiment.

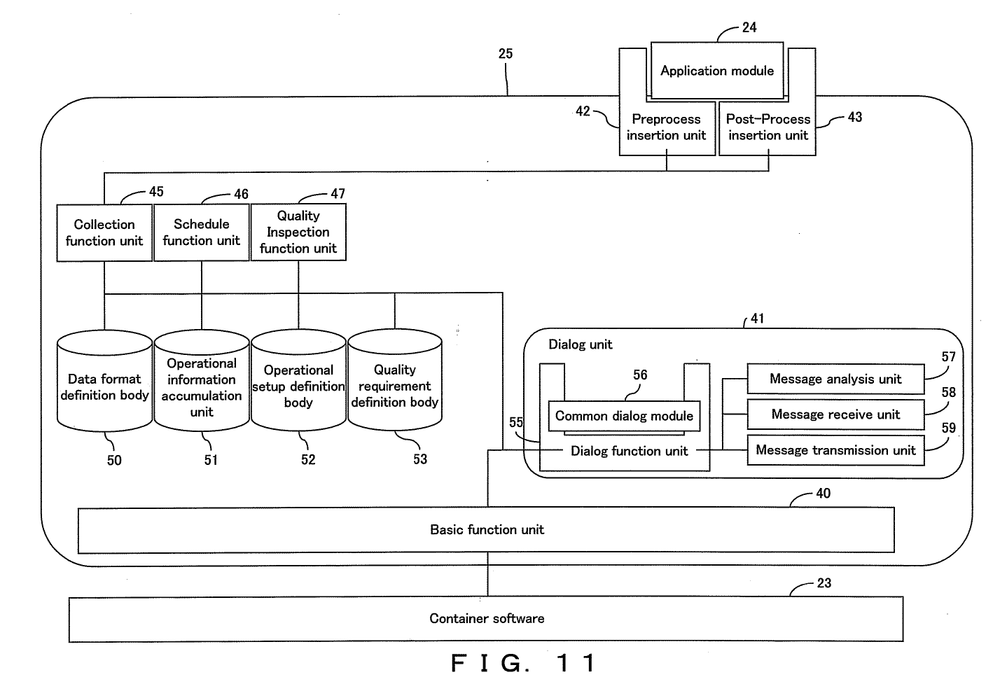

The next description is of the first embodiment by using FIGS. 11 through 57, in which the first description is of a detailed logical structure of node by using FIGS. 11 through 13 as an introduction to a detailed description of the preferred embodiment in accordance with the present invention. FIG. 11 shows a logical structural block diagram of common node. As described before, the program 25 according to the present invention, positioning itself between the application module 24 and container software 23, comprises a series of functional units and of data bases in addition to a basic function unit 40 for controlling the whole program, a dialog unit 41 for communicating with other nodes, a preprocess insertion unit 42 for inserting processing necessary for the present embodiment prior to the application module 24 executing an application and a post-process insertion unit 43.

The series of functional units include an operational information collection function unit 45 for collecting operational information about a service, a schedule function unit 46 for managing schedules such as reporting operational information to a service management node and a quality inspection function unit 47 for checking a quality of service when a created schedule has been executed. The series of data bases include a data format definition body 50 for storing a definition of data format to be used for storing operational information, an operational information accumulation unit 51 for accumulating a result of executing an application, that is, operational information such as information about processing for a request, an operational setup definition body 52 for storing a definition of setup information necessary for operating a node such as node power and a quality requirement definition body 53 for storing the quality requirement for each service such as a specified response time.

The dialog unit 41 includes, in the inside, a dialog function unit 55 for controlling data transmissions with the other functional units, a common dialog module 56 used for communications other than communications for management, a message analysis unit 57 for analyzing a message exchanged with other nodes, a message receive unit 58 for receiving a message from other nodes and a message transmission unit 59 for transmitting a message to other nodes.

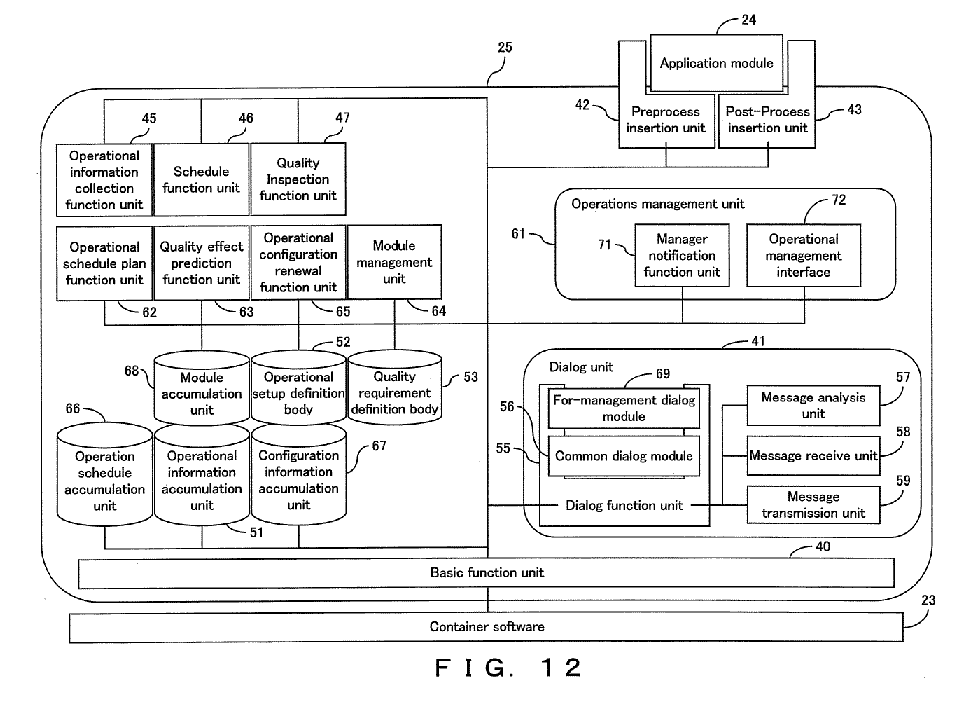

FIG. 12 shows a logical structural block diagram of service management node. The service management node comprises an operations management unit 61 for performing a communication with the operations manager of the system, also comprises the several additional functional units and the several additional data bases, in addition to the series of functional units and definition bodies which constitute a common node. Meanwhile, the inside of the dialog unit 41 is additionally equipped by a for-management dialog module 69 used for communication with other nodes for management. Also, in the inside of the operations management unit 61 is equipped by a manager notification function unit 71 for notifying the operations manager of necessary information and an operational management interface 72 used for a communication management.

The additional functional units include an operational schedule plan function unit 62 for planning an operation schedule for service, a quality effect prediction function unit 63 for predicting a quality of service in response to the planned schedule, a module management unit 64 for managing an application module and an operational configuration renewal function unit 65 for renewing the operational information within the group at the time of allocating an application module to a common node for instance.

The added databases include an operation schedule accumulation unit 66 for accumulating planned service schedules, a configuration information accumulation unit 67 for accumulating which node executes what service, et cetera, as configuration information, based on the operation schedule and a module accumulation unit 68 for storing application modules.

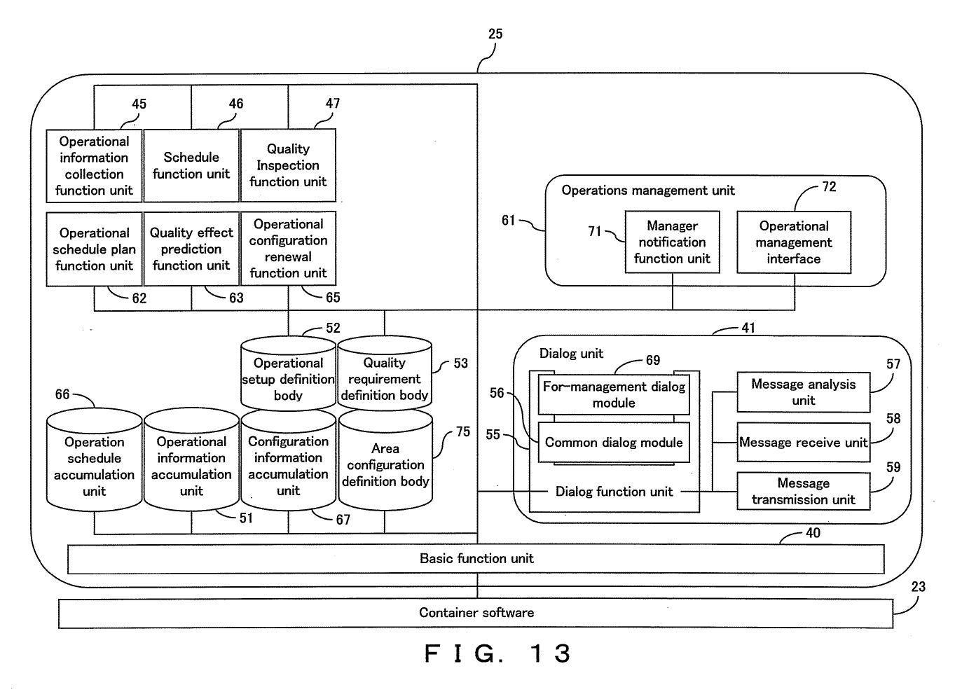

FIG. 13 shows a logical structural block diagram of area management node whose configuration resembles the service management node shown by FIG. 12, except that the area management node is satisfactorily configured to have functions for managing all nodes within the area, specifically without functions and data base relating to applications, hence eliminating an application module 24, preprocess insertion unit 42, post-process insertion unit 43, module management unit 64 and module accumulation unit 68; and instead, adding to the data base an area configuration definition body 75.

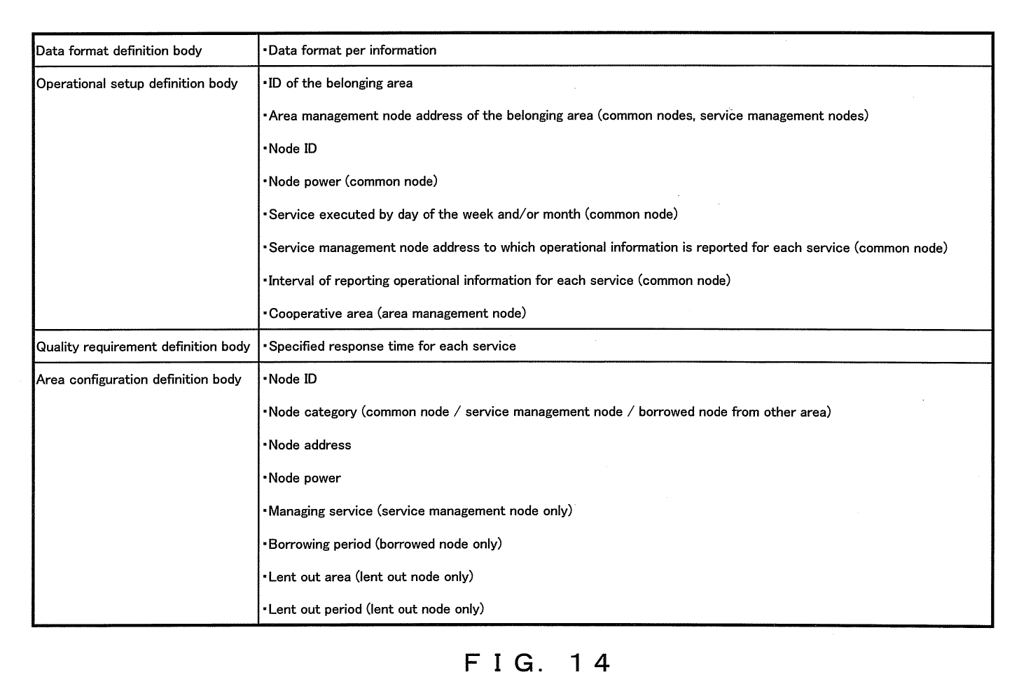

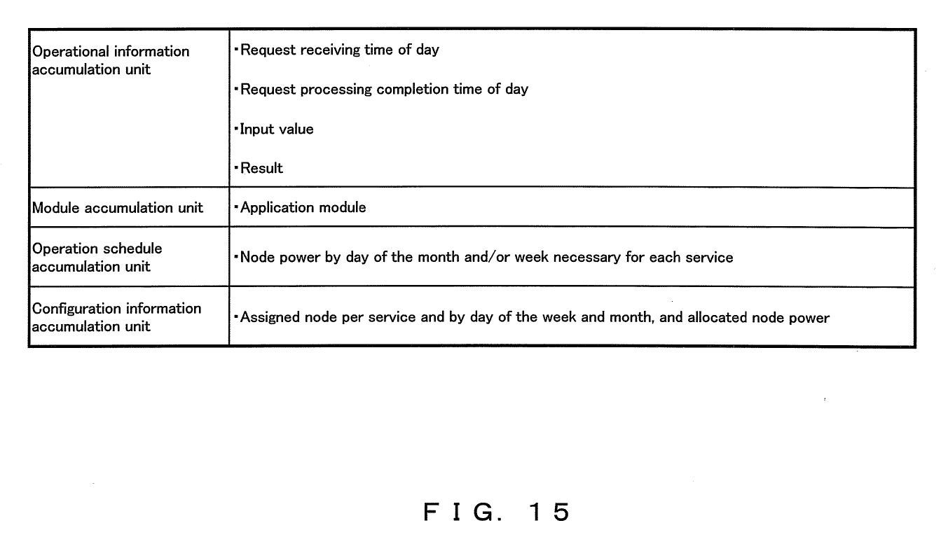

FIGS. 14 and 15 show information retained by a data base within each node described in association with FIGS. 11 through 13. First in FIG. 14, the data format definition body 50 stores a data format per information used for storing operational information. The operational setup definition body 52 stores various data such as ID of the belonging area as setup information necessary for operating the node. Among these pieces of data, the “area management node address” is retained by the common nodes and the service management nodes; the four bulleted items of data from “node power” to “interval for reporting operational information for each service” are retained by the common nodes; and the data for “cooperative area” is retained by the area management node. (Meanwhile, “borrowing area” and “cooperative area” mean same area.) Incidentally, while applications constituting a service are executed by the common nodes, and the node power is retained only by the common nodes in the present embodiment, if a service management node also executes an application, however, the node power will also be retained by the service management node. Then the quality requirement definition body 53 stores a specified response time as quality to be satisfied for each service.

The area configuration definition body 75 stores data, such as node ID, as data relating to the nodes existing within the area. Among these pieces of data to be stored, the “node category” contains the common nodes, service management nodes and a node category of the node borrowed from the other area. The data for “managing service” only applies to the service management node; the data for “borrowing period” only applies to the borrowed node; the “lent out area” and “lent out period” only apply to the node of which the node power is lent out to another area.

FIG. 15 describes data accumulated by various accumulation units. The operational information accumulation unit 51 comprised by the common node stores operational information as a result of executing the application by its own node, while the one comprised by the service management node stores the operational information reported by the common nodes. The number of executed requests can be identified by the time of receiving a request, etcetera, based on the contents of data.

The module accumulation unit 68, comprised by the service management node, stores modules necessary to execute the service managed by the node; and the operation schedule accumulation unit 66 stores a list of node power by the day of the month and/or week necessary for each service and accumulates the created past schedule in order to compare with the actual result. Furthermore, the configuration information accumulation unit 67 accumulates data of which common node executes what service based on the operation schedule including the past data.

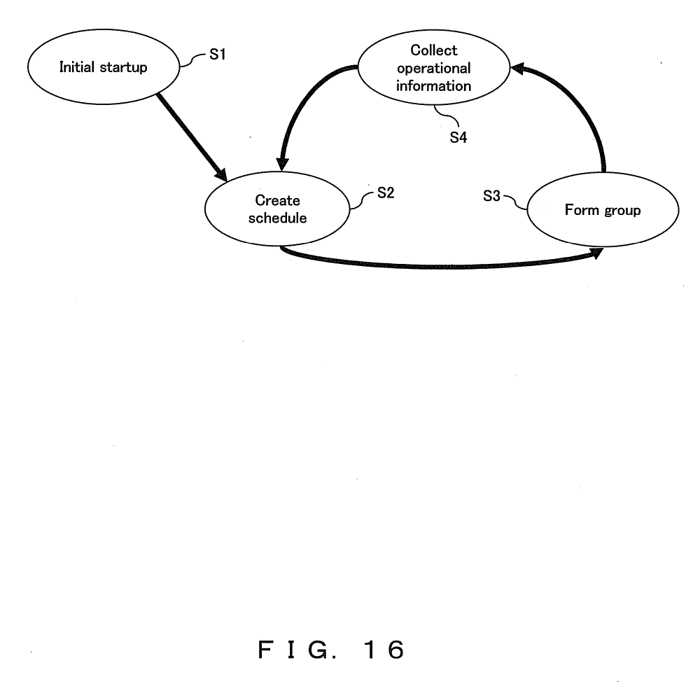

The next description is about a sequence of processing executed by each node according to the present embodiment. FIG. 16 shows the whole of such sequence, that is, overall description of the system operation cycle. First at the initial startup of the system, the startup sequence, that is, the processing basically is for each node within its own area registers the information about its own node to the area management node (step S1; simply “S1” hereinafter).

Subsequent processing is to execute the sequence of creating a schedule (S2), in which each service management node creates an optimum configuration schedule for maintaining a quality of service based on the node power necessary for executing the service and the operational information collected during the operation.

Then execute the sequence of grouping (S3), which forms a group made up of a service management node and usually a plurality of common nodes for each service based on the schedule created in the scheduling sequence.

The next sequence is to collect operational information (S4), in which the operational information reported during the system operation is collected to check the quality of service. The result will be used for the sequence of creating schedule in the step S2.

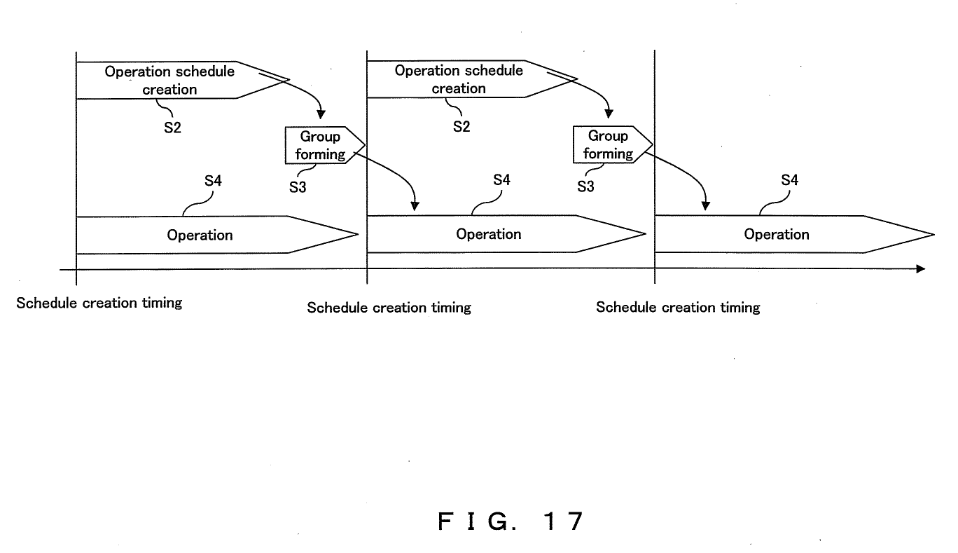

FIG. 17 describes the timing of creating operation schedule and the system operation by using a time series chart. When an operation schedule creation timing arrives, an operation schedule is created (S2). The schedule will be used for the operation after the next schedule creation timing, and as an operation schedule is created, a group is formed (S3), the result of which will be used for the operation after the next schedule creation timing (S4).

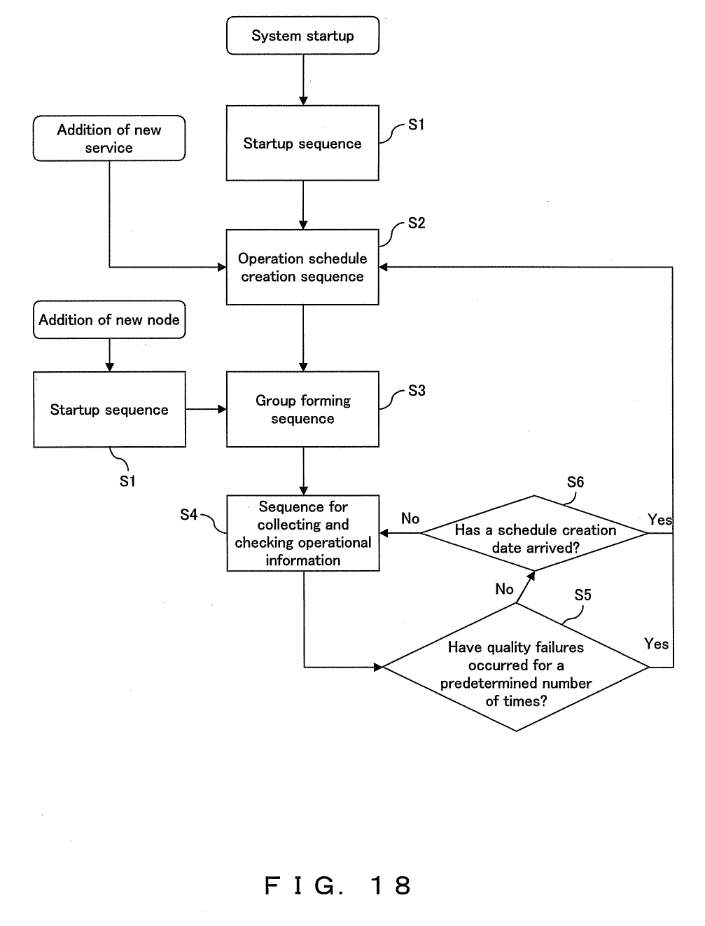

FIG. 18 is a flow chart showing an overall relationship of sequence corresponding to the system operation cycle shown by FIG. 16. In FIG. 18, as the system starts up, the startup sequence is processed (S1), followed by each service management node processing the sequence of an operation schedule creation (S2) If a new service is added to the system, the content of the addition will be reflected in the above sequence.

Once an operation schedule is created, the area management node performs the sequence of forming group (S3). If a new node is added, the startup sequence for the new node is executed in step S1, followed by adding the new node in the sequence of forming group. Incidentally, an operation schedule will not be revisited since it is already done in step S2, and therefore the group forming is such that the new node will be added to the service being executed either in a shortage of node power or in a marginal node power.

Then, while the system is being operated, the service management node performs the processing of collecting and checking the operational information (S4). Then, judge whether or not the number of quality failures has occurred no less than a predefined number of times based on the checking result of the operational information (S5) and, if the number has not reached the predefined number of times, judge whether or not the next schedule creation date, that is, the schedule creation timing shown by FIG. 17 has come (S6). If the timing has not come, the sequence of step S4 continues. On the other hand, if the number of quality failures, such as exceeding the response time, has occurred no less than the predefined times in the judgment for step S5, or the judgment in step S6 is that the schedule creation date has arrived, the processing goes back to step S2 and another schedule creation sequence will be performed.

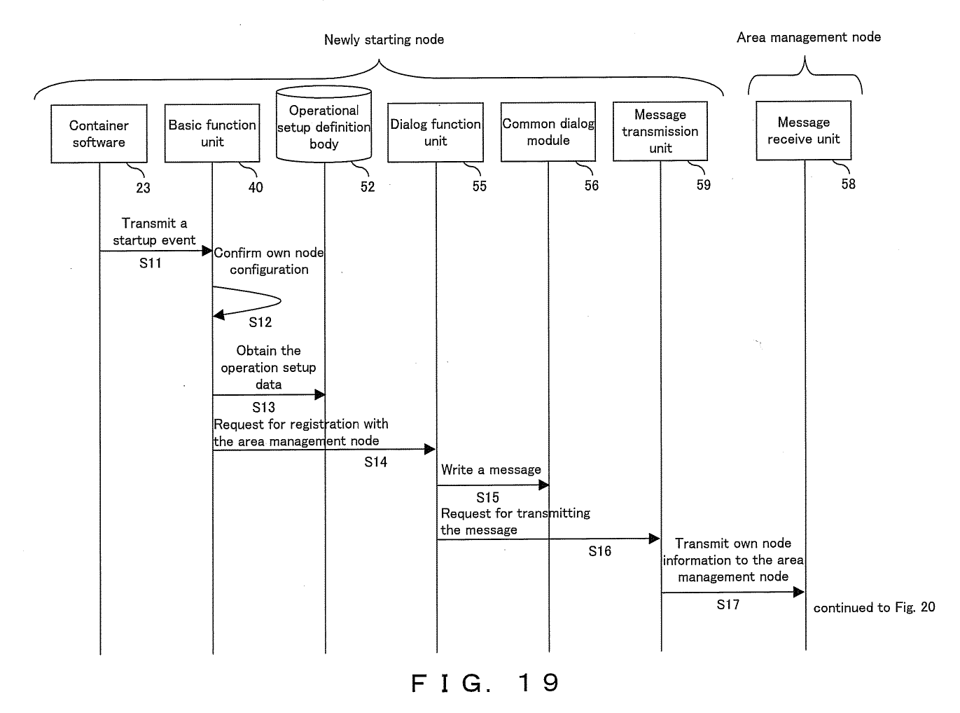

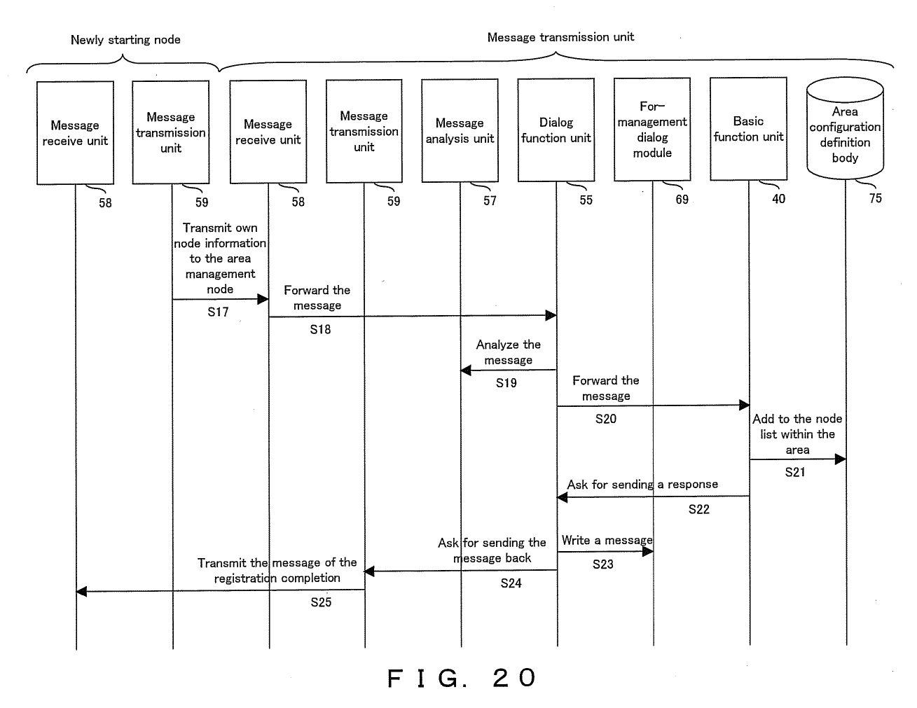

FIGS. 19 and 20 together show a detail flow chart of the startup sequence in step S1 shown by FIG. 18. In this sequence, the processing is for the nodes newly starting up as described above, i.e., the common nodes and service management nodes, existing within the area register their own node with the area management node.

In FIG. 19, first of all the container software 23 transmits a startup event to the basic function unit 40 (S11) which in turn confirms the own node configurations such as the functional units installed therein (S12), obtains the address for the area management node of the area, to which the own node belongs, from the operational setup definition body 52 which defines it statically as the operation setup data (S13), and requests the dialog function unit 55 for registration with the area management node (S14).

The dialog function unit 55 lets the common dialog module 56 write a message (S15) and asks the message transmission unit 59 to transmit the message (S16). The message transmission unit 59 transmits its own node information, such as address and node power, to the message receive unit 58 comprised by the area management node to request for registering its own node information (S17).

Turning to FIG. 20, the message receive unit 58 over at the area management node receives the message from the newly starting node and forwards the message to the dialog function unit 55 (S18) which in turn requests the message analysis unit 57 for analyzing the message (S19) and notifies the basic function unit 40 of a result of the analysis in the form of message (S20).

The basic function unit 40 registers the address and node power of the newly starting node as a node list contained by the area configuration definition body 75 (S21) and asks the dialog function unit 55 for responding back to the applicable node with a message of registration completion (S22). The dialog function unit 55 asks the for-management dialog module 69 to write a message (S23) and the message transmission unit 59 to send the written message back (S24). The message transmission unit 59 transmits the message of the registration completion to the message receive unit 58 comprised by the newly starting node (S25).

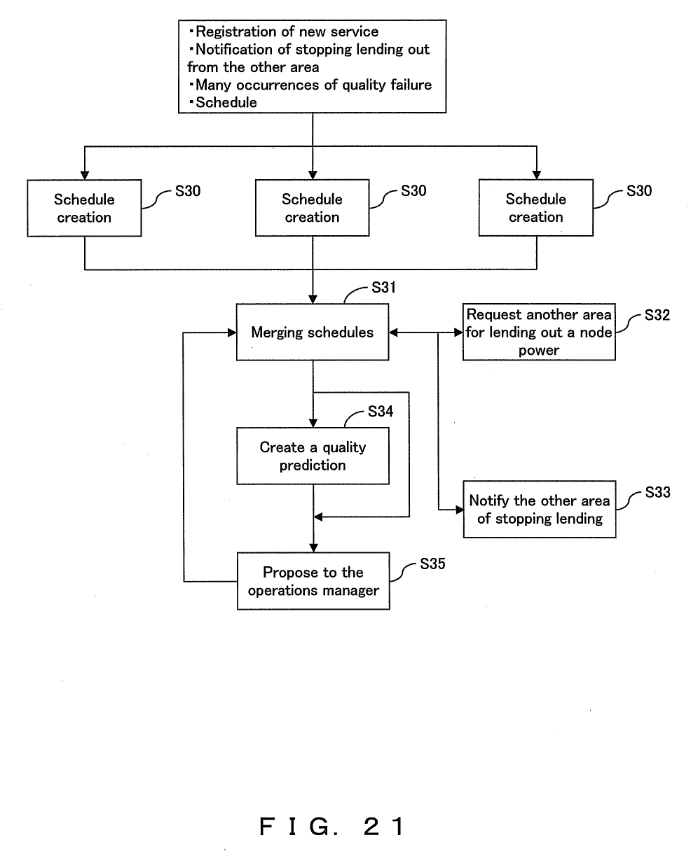

The next description is about an operation schedule creation sequence. FIG. 21 is an overall sequence relation chart for creating an operation schedule. In FIG. 21, the operation schedule creation sequence will be started in the following occasions, that is, a new service is registered for the system; a notification is received from another area effecting the end of lending the node power from the area; many quality failures have occurred; and the scheduler starting up at a schedule creation timing described in association with FIG. 17.

In the overall sequence, first, each service management node that is responsible for a service creates a schedule for the service (S30), then the area management node merges these schedules (S31) and, if the merged result indicates that all the schedules cannot be executed by only the node power within its own area, area management node requests another area for lending node power (S32) or, if node power within its own area is lent out to another area, it transmits a notification to the area of stopping lending the node power (S33).

For instance, if it is possible to borrow node power from another area, going back to step S31 for recreating another operation schedule in response to each service comprehending the node power to be borrowed therefrom.

As a result of the schedule merge in step S31, a quality of service will be predicted for the created operation schedule for each service in a required basis (S34). The quality of service prediction is basically performed if there is a shortage of node power in executing the schedules for the respective services created by the service management nodes in step S30. Otherwise the prediction of the quality of service is not performed.

Subsequent processing is to make a proposal to the operations manager about the created operation schedule for each service as a result of the merging schedules performed in step S31 or about the result of predicting the quality of service performed in step S34 (S35) and, if the operations manager approves an execution of the operation schedules for all the services, then the operation schedule creation sequence completes, followed by operating the system in accordance with the operation schedules as is. If the operation manager does not approve even one schedule or instructs a modification, then go back to step S31 for performing the sequence of the schedule merging and thereafter. Note that the proposal to the operations manager in step S35 is not necessarily a compulsory and an autonomous cycle by the system, i.e., schedule creation, group forming and operational information collection as described in association with FIG. 16, does not need such a proposal.

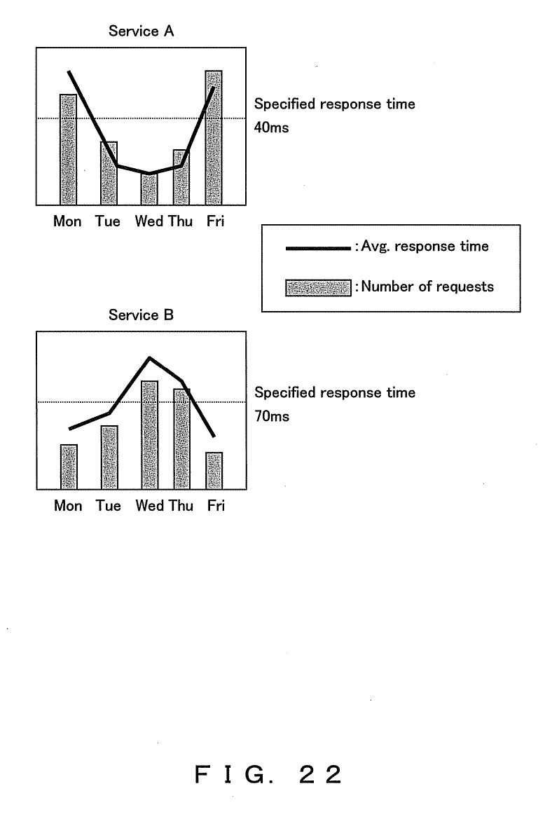

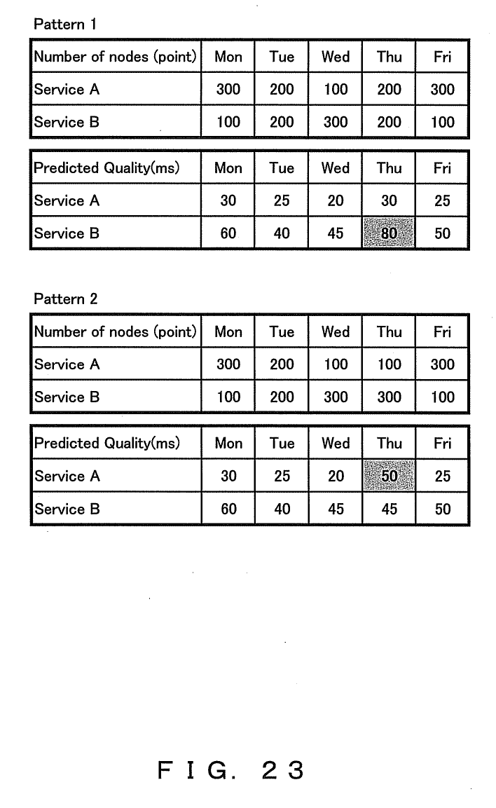

FIGS. 22 and 23 describe the logic of operation schedule creation. In this operation schedule creation logic, a schedule is created so as to satisfy a specified response time for each service for instance. FIG. 22 exemplifies the number of requests and average response time per each week day for each service. For example, the specified response time for the service A is 40 ms which is exceeded on Monday and Friday due to the number of requests, hence the average response time exceeding the specified response time.

FIG. 23 shows an example of node power allocation plan for each service. The numbers in the table mean the sum of node power necessary for executing applications constituting the respective services. Allocation of node power by the point numbers for each week day per the services A and B, respectively, will achieve the response time as a predicted quality of service. The tables show that, in the pattern 1, the node powers of 200 points are allocated to the services A and B, respectively, on Thursday, estimating the response time for the service B being predicted as 80 ms to exceed the specified response time, while in the pattern 2, the service A is allocated by 100 points and the service B by 300 points, both on Thursday, estimating the response time for the service A being predicted as 50 ms to exceed the specified response time as well.

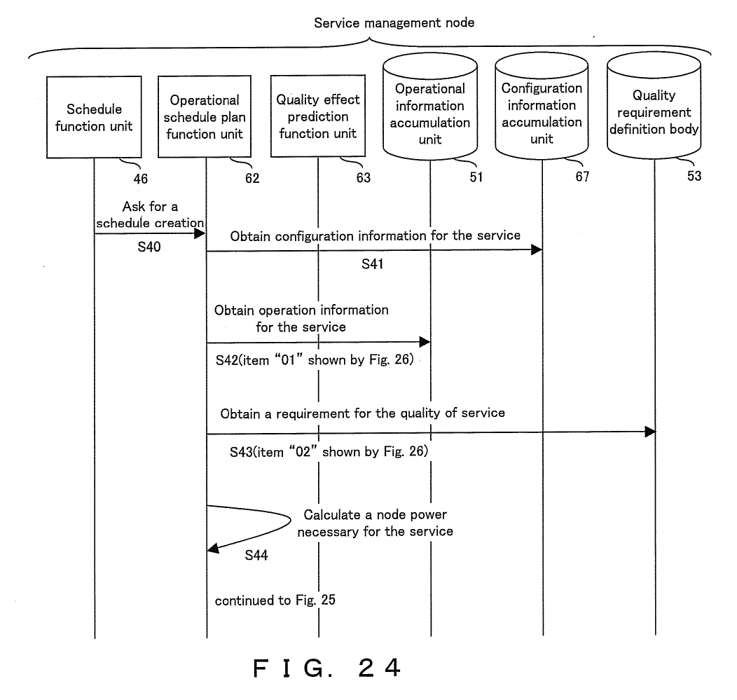

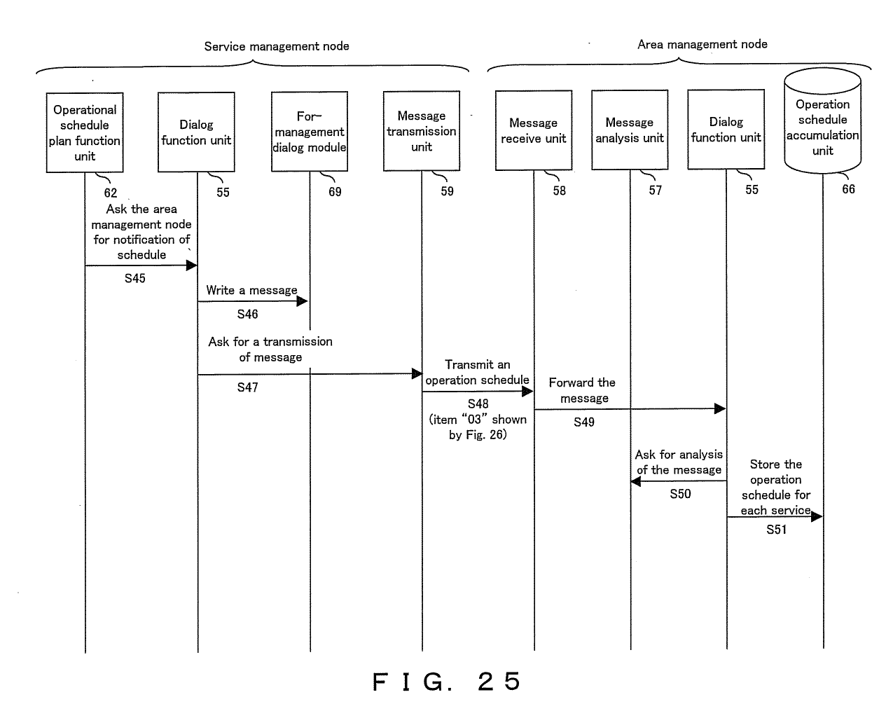

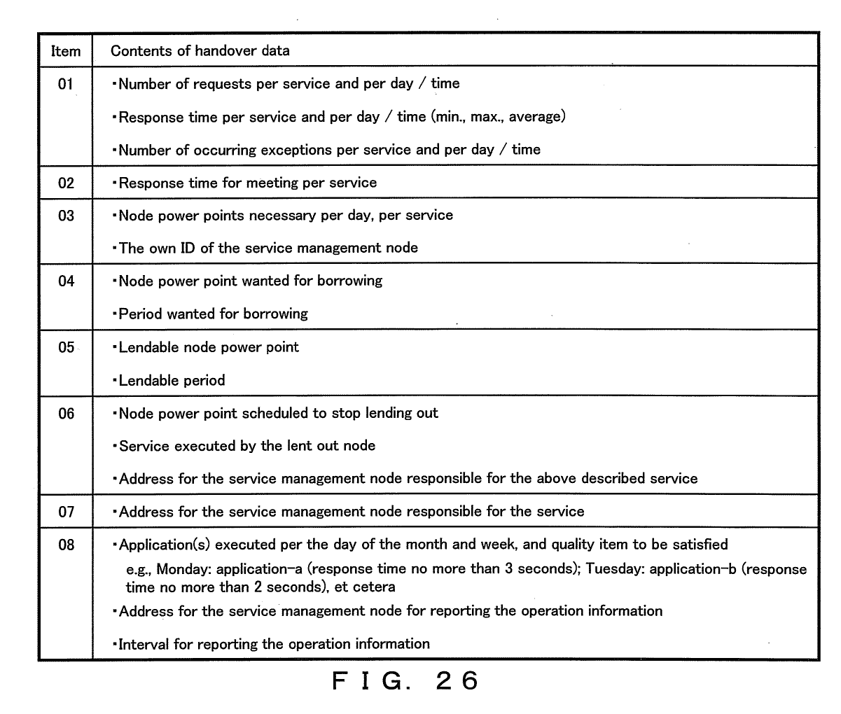

FIGS. 24 and 25 together show a detail sequence of creating an operation schedule per service, that is, step S30 shown by FIG. 21. The service management node responsible for each service performs the processing of the sequence. First, the schedule function unit 46 asks for creating a schedule to the operational schedule plan function unit 62 (S40) which obtains configuration information such as the responsible node for each service and the node power from the configuration information accumulation unit 67 (S41) and operational information such as the number of requests for each service and the response time from the operational information accumulation unit 51 (S42). Here, the data handed over from the operational information accumulation unit 51 to the operational schedule plan function unit 62 are by the content of item “01” listed in the handover data details table shown by FIG. 26.

Subsequently, the operational schedule plan function unit 62 obtains the response time to be satisfied for each service from the quality requirement definition body 53 as a requirement for the quality of service (S43). This data is the content of item “02” listed in the table shown by FIG. 26. Then the operational schedule plan function unit 62 calculates node power necessary for executing the applications constituting the service (S44).

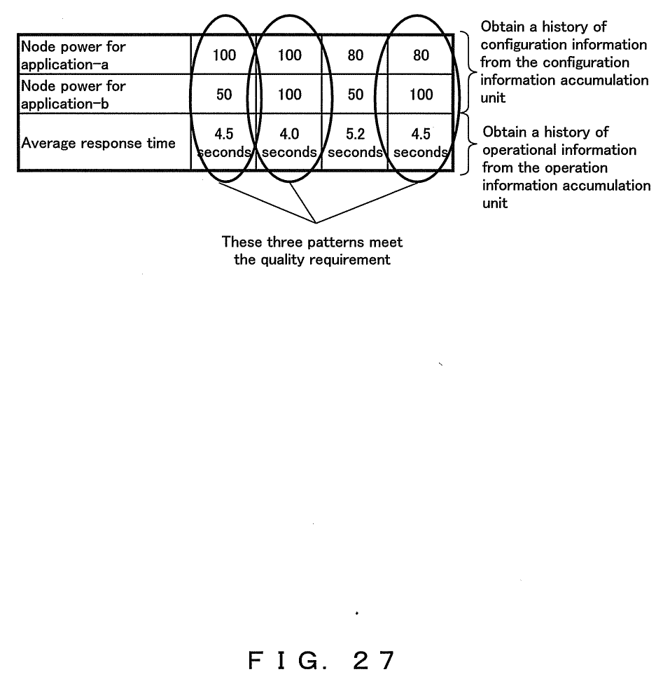

FIG. 27 shows an actual example of configuration information and operation information accumulated from the past, which will be used for calculating node power. Let it define that the service therein is constituted by two applications-a and -b and the response time is specified as within 5 seconds as a requirement for the quality of service.

In FIG. 27, three patterns meet the requirement for quality, that is, the response time not exceeding 5 seconds. Among these patterns, the one requiring the least total node power, that is, 100 points for the application-a and 50 points for the application-b, is selected for calculating the node power in step S44 shown by FIG. 24.

FIG. 25 is a continuation of sequence from FIG. 24. First, the operational schedule plan function unit 62 requests the dialog function unit 55 for notifying the area management node of the schedule (S45), the dialog function unit 55 asks the for-management dialog module 69 for writing a message (S46) and asks the message transmission unit 59 for transmitting the written message (S47), and the message transmission unit 59 transmits the operation schedule to the area management node (S48). Here, the transmitted data include the service, the node power point necessary for each day and the ID for identifying the own node as shown by the item “03” in FIG. 26.

Over at the area management node, the message receive unit 58 receives the message transmitted by the service management node and forward the message to the dialog function unit 55 (S49) which in turn requests the message analysis unit 57 for analyzing the message (S50) and then the operation schedule accumulation unit 66 stores the analysis result as an operation schedule for each service (S51).

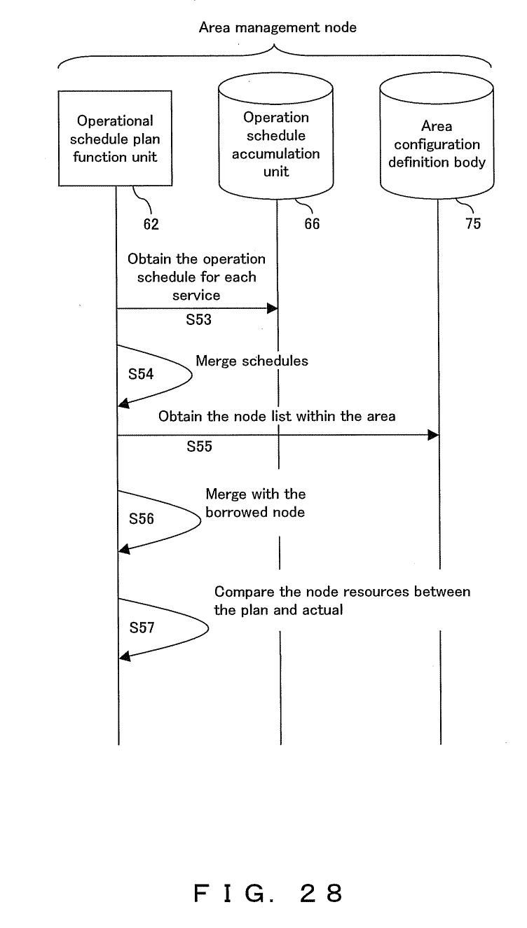

FIG. 28 shows a detail sequence of schedule merging in step S31 shown by FIG. 21. The area management node executes the processing of this sequence. First, the operational schedule plan function unit 62 obtains the operation schedule for each service from the operation schedule accumulation unit 66 (S53), merges the schedules (S54), obtains the node list within the area from the area configuration definition body 75 (S55), perform a merging including information about a borrowed node from another area if it is possible to borrow the node as a result of performing a request for borrowing node power (S56), and calculates node power to be actually allocated to each service by comparing the node resource between the plan and actual based on the available node resource (S57).

As a result of the above described, if it is possible to satisfy the schedule by the node power available within the area, or the step S32 is already done, then proceed to either steps S34 or S35. If there is a shortage of node power within the area and there is a node being lent out to another area, then proceed to step S33. If there is a shortage of node power within the area, nor is there a node being lent out to another area, nor has the step S32 been executed, then proceed to step S32.

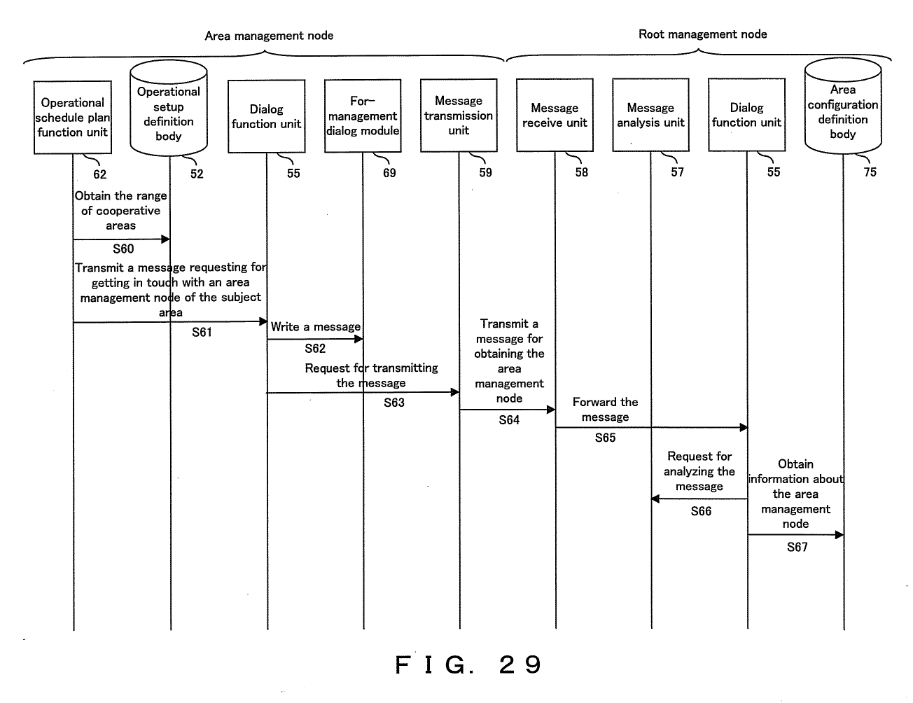

FIGS. 29 through 31 show a detail sequence of step S32 shown by FIG. 21, that is, requesting other area for borrowing power. FIG. 29 is the sequence of processing for the area management node, of the area wanting to borrow node power, to ask the root management node that manages all the areas for the address for the area management node of the area from which the borrowing area wishes to borrow node power. First, the operational schedule plan function unit 62 obtains the range of cooperative areas from the stored contents of the operational setup definition body 52 (S60). Let it assume here that the areas available for borrowing nodes are statically defined so as to be stored in the operational setup definition body 52 as shown by FIG. 14. The operational schedule plan function unit 62 transmits a message to the root management node (S64) requesting for getting in touch with an area management node by way of the dialog function unit 55 (S61), for-management dialog module 69 (S62) and message transmission unit 59 (S63) in order to transmit a message to the root management node for acquiring the address for the area management node within the cooperative area, that is the area of the subject.

Let it assume here again that the area having a node available to lend out is statically defined per area by the area manager for instance. A judgment for actual availability is basically made as to whether or not a communication delay between the applicable areas is negligible and the communication therebetween is permitted. It is also assumed that the area managers of the two areas may sign up a contract for cooperation.

For an area from which node power can be borrowed even with not so significant communication delay, the actual node power will be adjusted by multiplying a number smaller than 1 (one). For a node which is expected to perform 80% due to a communication delay for the borrowing area, the borrower treats it as 80-point node power if it has originally a 100-point power.

Over at the root management node, the processings are performed by the message receive unit 58 receiving and forwarding the message and by way of the dialog function unit 55 and message analysis unit 57 in the steps S65 through S67 so that the dialog function unit 55 obtains the address for the area management node of the inquired area from the area definition body for example within the root management node, that is, from a list of area management nodes (S67). Incidentally, let it assume that the configuration of the root management node resembles that of the area management node described in association with FIG. 13.

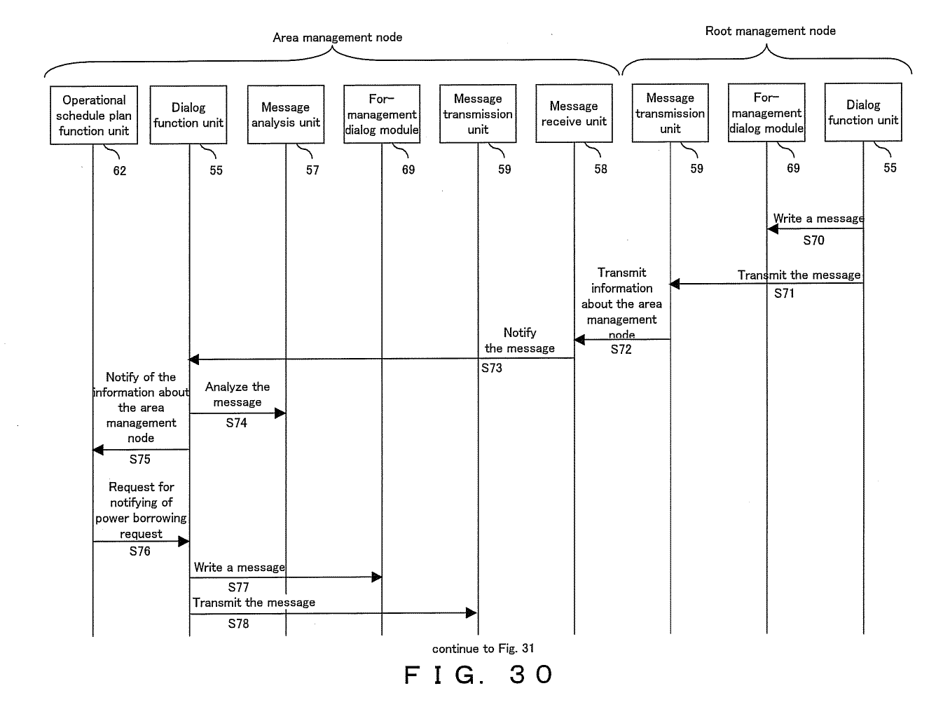

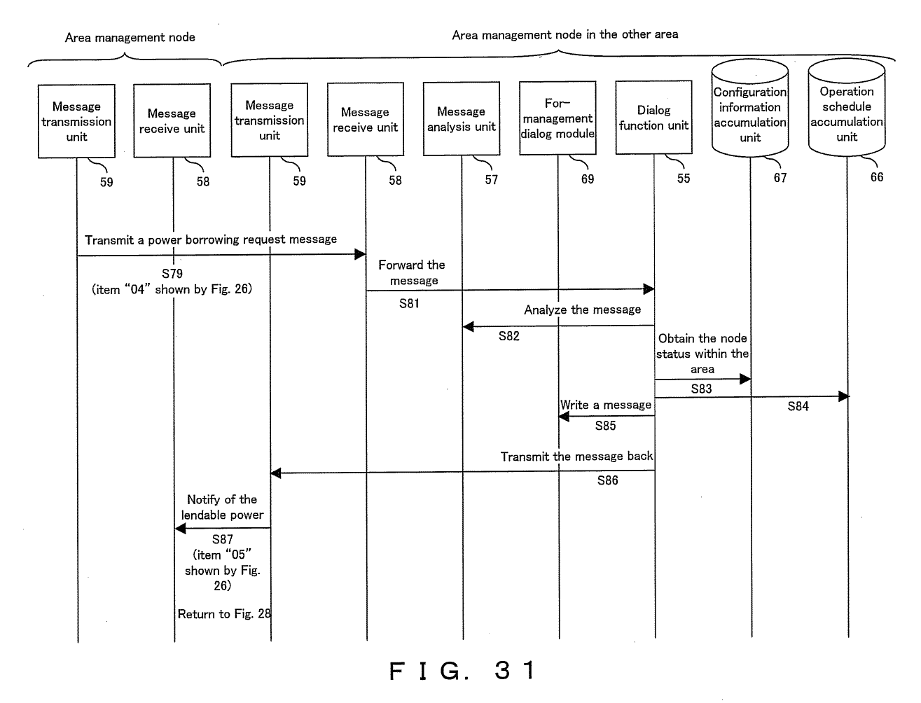

FIGS. 30 and 31 are continuation from the sequence of FIG. 29. At the root management node, the information about the area management node of another area is sent to the area management node which has transmitted the inquiry through the processings performed by the dialog function unit 55, for-management dialog module 69 and message transmission unit 59 in the steps S70 through S72.

Back at the area management node, the processings by the message receive unit 58, dialog function unit 55 and message analysis unit 57 in the steps S73 through S75 transmit the information about the area management node, that is, the address thereof to the operational schedule plan function unit 62.

Then, in order to transmit a message from the area management node to the area management node of the other area to request for borrowing node power, the processing is performed by the operational schedule plan function unit 62, dialog function unit 55, for-management dialog module 69 and message transmission unit 59 in the steps S76 through S79, followed by transmitting a request message of borrowing power to the area management node of the other area. The data transmitted by the message contain a node power point wanted for borrowing and a period wanted for borrowing as shown by the item “04” in FIG. 26.

Turning to FIG. 31, the power borrowing request message is analyzed by the message receive unit 58, dialog function unit 55 and message analysis unit 57 comprised by the area management node of the other area in the processing of steps S81 and S82. The dialog function unit 55 obtains the node status within the area from the configuration information accumulation unit 67 (S83) and obtains the node power plan necessary for each service from the operation schedule accumulation unit 66 (S84) to judge whether or not lending out node power is possible according to the result of the above noted analysis.

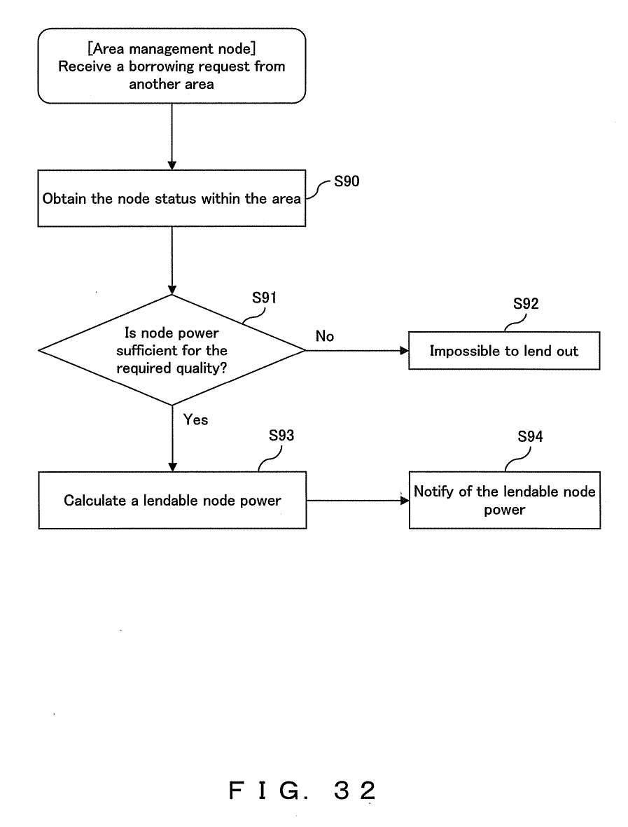

FIG. 32 shows a detail flow chart of how a capability of lending node power is judged. The processing is initiated when receiving a request for lending node power from another area. First, information about nodes assigned to each service available from the configuration information accumulation unit 67 and power plan necessary for each service available from the operation schedule accumulation unit 66 as the node status are obtained (S90), node power required by the schedule is compared with the actually allocated node power to judge whether or not the node power is currently sufficient for the required quality of service (S91) and, if the judgment is “insufficient”, then lending node power is determined as impossible (S92). If the judgment is “sufficient”, a lendable node power is calculated by subtracting the required node power from the allocated node power to obtain a surplus node power (S93) and the lendable node power is notified to the area management node of the other area requesting for lending a power (S94).

That is, in the processing of steps S85 through S87 shown by FIG. 31, the dialog function unit 55 and message transmission unit 59 notify the area management node of the area requesting for lending the power of the lendable power. The data contained by the notification message are the lendable power point and a lendable period as shown by the item “05” in FIG. 26. Upon completing the sequence shown by FIG. 31, the processing goes back to step S31 shown by FIG. 21, that is, the processing of FIG. 28.

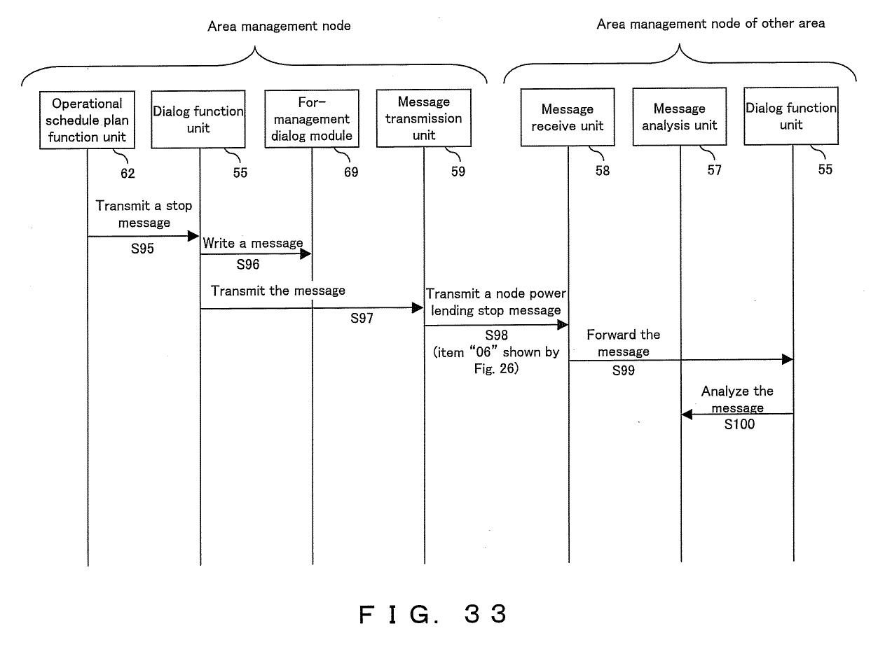

FIG. 33 shows a detail sequence chart for step S33 shown by FIG. 21, that is, notifying stopping lending to the other area. In FIG. 33, first in the area management node of the area lending out node power, the processing by the operational schedule plan function unit 62, dialog function unit 55, for-management dialog module 69 and message transmission unit 59 in the steps S95 through S98 transmit a node power lending stop message to the area management node of another area borrowing the power. The data contained by the message are the node power point scheduled to stop lending out, service executed by the lent out node and address for the service management node responsible for the above described service as shown by the item “06” in FIG. 26.

Having received the node power lending stop message, area management node of the other area, the processing by the message receive unit 58, dialog function unit 55 and message analysis unit 57 in the steps S99 and S100 analyzes the message content, based on which the notified area management node starts a schedule creation sequence.

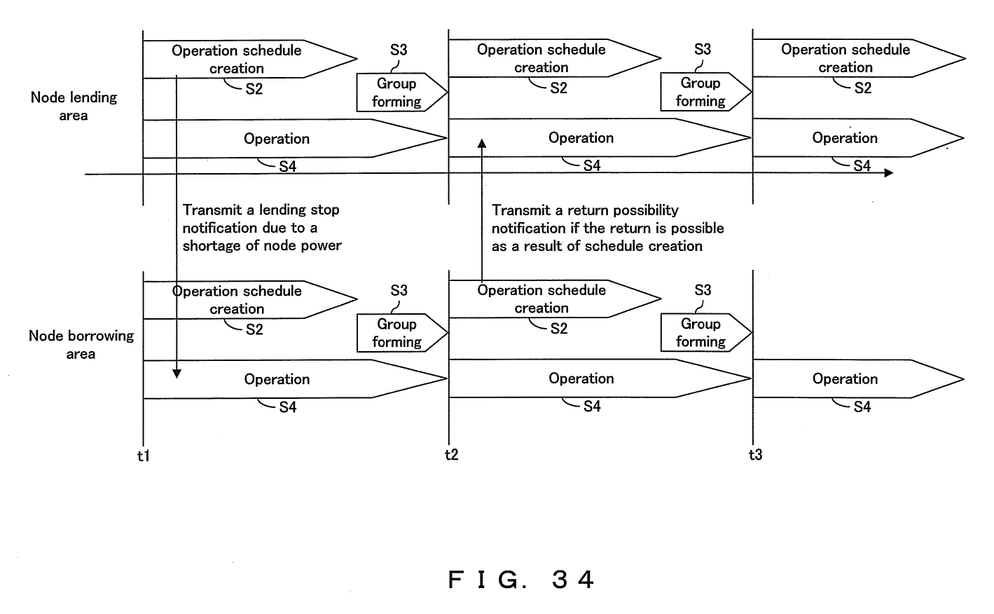

FIG. 34 describes the operation schedule creation and handling in group forming in response to the node power lending stop notification on the both sides, i.e., the node lending and borrowing sides. First, in the operation schedule creation sequence the node lending area transmits a node power lending stop notification to the node power borrowing area which is in a shortage of node power. The node power borrowing area is unable to comply with the notification and return the borrowed power immediately, and therefore continues the operation by including the borrowed node power until the next schedule creation timing.

The node power borrowing area judges whether or not it is possible to return the borrowed node power in an operation schedule created at the next schedule creation timing t2 and, if it is possible to return it, notifies the node power lending area of it and create an operation schedule without including the borrowed node power.

The node power lending area is also creating an operation schedule, but it has to wait until the next schedule creation timing t3 for an operation schedule creation including the node power to be returned, because a return possibility notification from the node power borrowing area has not been received at this operation schedule creation timing t2, negating an operation schedule creation by including the lent out node power; and even if a return possibility notification is received from the node power borrowing area in the middle of an operation schedule creation, the created operation schedule itself cannot utilize returned node power in the above described group forming of the step S3, leaving only an option to use the returned node power for a service group which is running at a marginal node power for instance.

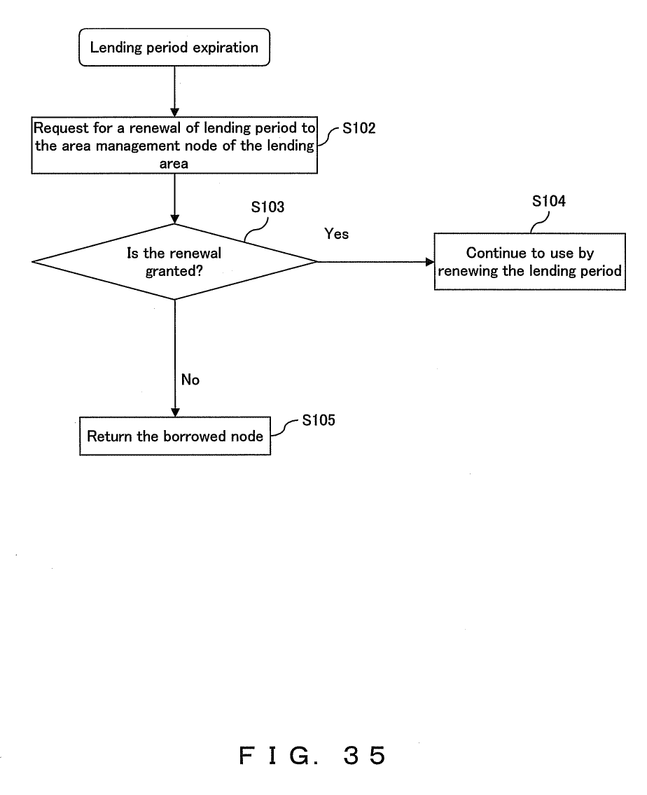

Node power is lent by specifying the lendable period and expiration date. When the expiration date arrives, the area management node of the node power borrowing area can request the area management node of the lending area for a renewal of the lending period unless the above described lending stop notification is given. FIG. 35 shows a flow chart of the node power borrowing period renewal request processing.

In FIG. 35, when the expiration date arrives, the processing starts with the area management node of the node power lending area receiving a lending period renewal request (S102) and, depending on the renewal being granted or not (S103), the lending period will be renewed if it is granted (S104), enabling a continuous use, otherwise the borrowed node power will be returned (S105).

Incidentally, a node return processing done by the area management node of the node power borrowing are sending a return message to the area management node of the lending area followed by modifying the configuration information accumulation unit 67 and area configuration definition body 75 of the respective nodes in the case of receiving a node power lending stop notification as shown by FIG. 34 or a renewal of lending period not being granted as shown by FIG. 35.

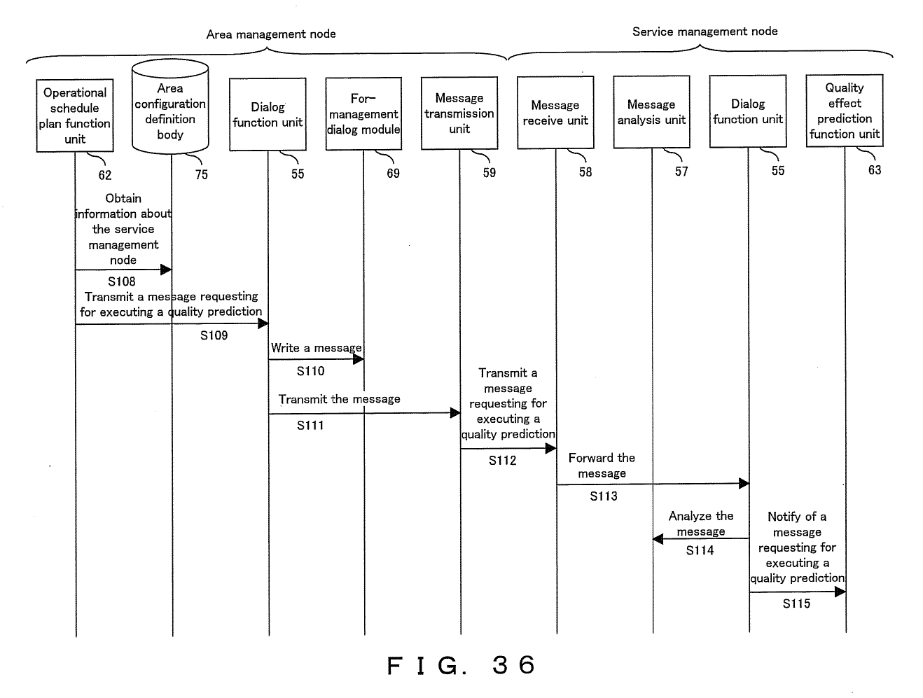

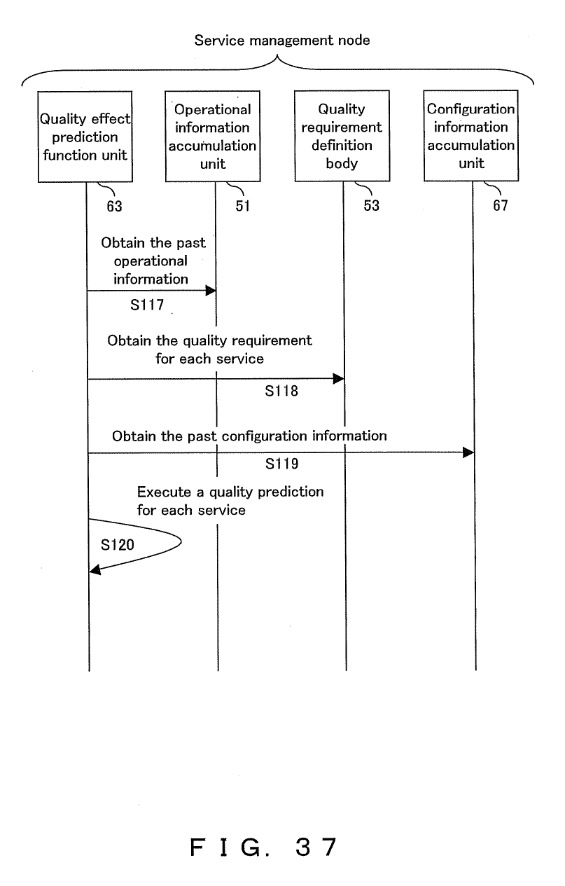

FIGS. 36 and 37 together show a detail sequence of step S34 shown by FIG. 21, that is, for executing a quality prediction. As described above, the processing will be executed only when there is a shortage of node power allocated to the schedule for each service created by the service management node as a result of schedule merging by the step S31 for example.

Referring summarily to FIG. 36, the area management node requests the service management node for executing a quality prediction. Specifically, the operational schedule plan function unit 62 obtains the information from the area configuration definition body 75, such as address, about the service management node that manages the service of which the quality prediction is necessary (S108), and through the processings by the dialog function unit 55, for-management dialog module 69 and message transmission unit 59 in the steps S109 through S112, the node power allocatable to each service according to the merged schedule within the area is notified and a message requesting for executing a quality prediction is transmitted over to the service management node.

Over at the service management node, through the processing by the message receive unit 58, dialog function unit 55 and message analysis unit 57 in the steps S113 through S115, the content of the message is notified to the quality effect prediction function unit 63.

Now turning to FIG. 37, the quality effect prediction function unit 63 obtains the past operational information from the operational information accumulation unit 51 (S117), the quality requirement for each service from the quality requirement definition body 53 (S118) and the past configuration information from the configuration information accumulation unit 67 (S119) to execute a quality prediction for each service (S120), in which a quality for each service such as response time, is predicted based on the node power allocated to the actual service and the past operational performance as exemplified by FIG. 27.

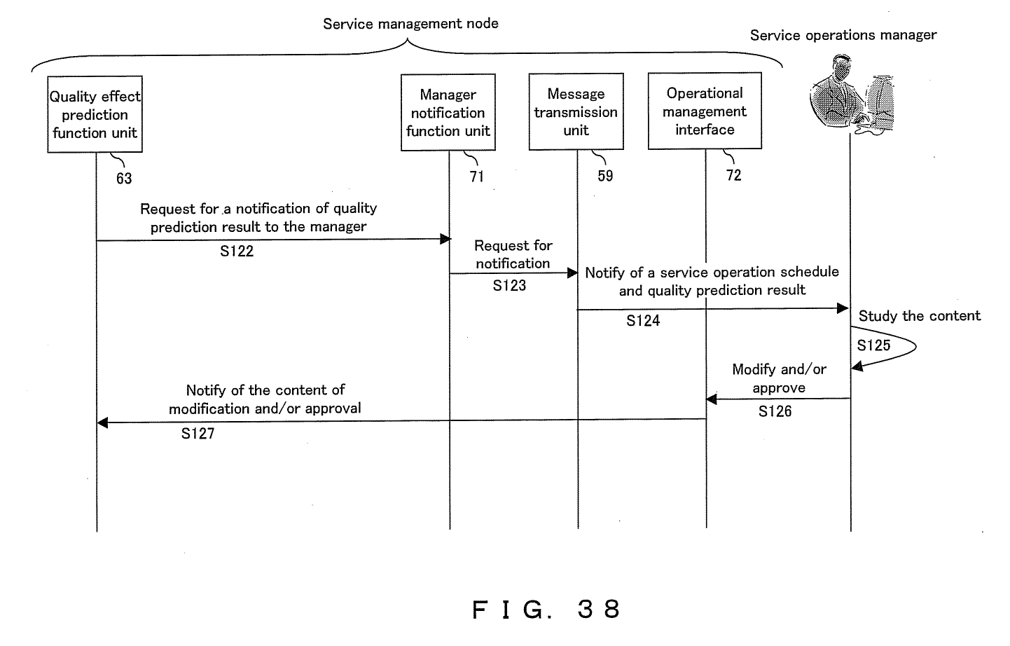

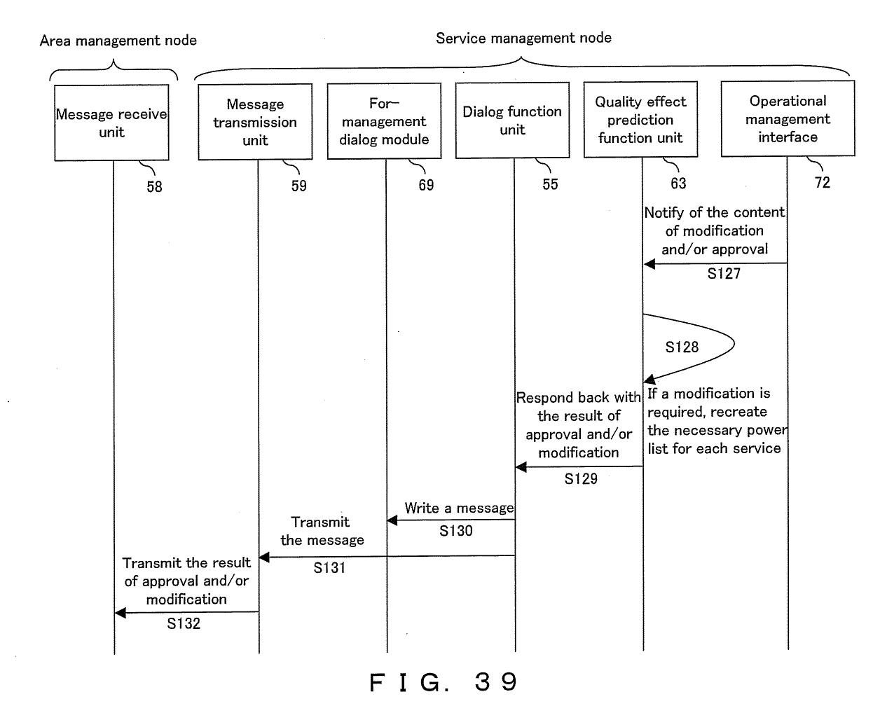

FIGS. 38 and 39 together show a detail sequence of the step S35 shown by FIG. 21, that is, for proposing to an operations manager. As described above, this sequence is basically performed when the node power is in short supply and after the quality prediction is executed, but the sequence is not performed basically when there is a sufficient node power in order to accomplish an autonomous operation of the system. In the initial stage of system operation for instance, the sequence shown by FIGS. 38 and 39 is executed for confirming the operation state of the system, but it is not executed in a steady state of operation unless there is a shortage of node power.

In FIG. 38, at the service management node, through the processing by the quality effect prediction function unit 63, manager notification function unit 71, message transmission unit 59 and operational management interface 72 in the steps S122 through 124, the service operations manager is notified of the service operation result and quality prediction result.

The service operations manager, assuming to reside in a zone communicable with the service management node within the system, studies the operation schedule and quality prediction result sent from the service management node (S125), and notifies the quality effect prediction function unit 63 of a modification, such as increasing the node power allocated to the service A for shortening the response time while decreasing the node power allocated to the service B that much in accordance with the priority among the services, et cetera, or of the content of approving the operation schedule by way of the operational management interface 72 through the processing in the steps S126 and S127. An approval pattern may be such that the service operations manager can select either the patterns 1 or 2 as described in association with FIG. 23.

FIG. 39 is a continuation of sequence from FIG. 38. At the service management node, the quality effect prediction function unit 63, if there is an instruction for modification from the operations manager, recreates a node power list necessary for each service in response to the instruction (S128) and transmits the approval by the operations manager and/or the result of the modification, including the recreation result, to the message receive unit 58 comprised by the area management node through the processing by the dialog function unit 55, for-management dialog module 69 and message transmission unit 59 in the steps S129 through S132. Note that the processing of recreating the necessary node power list in step S128 is to increase the node power for the service A while decrease the node power for the service B, according to the above described instruction for modification from the operations manager for example.

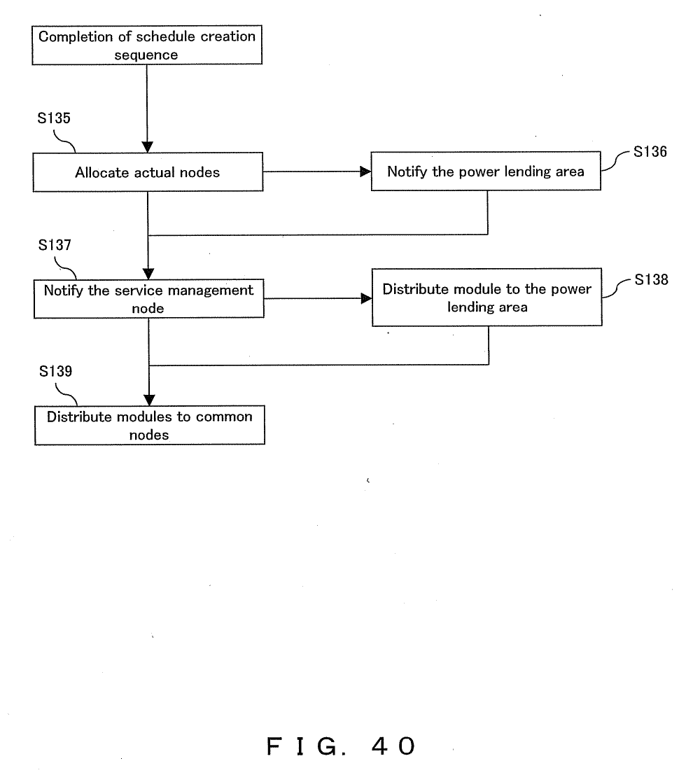

This concludes the description of operation schedule creation sequence described in association with FIG. 21, and now moves to a detail of step S3 shown by FIG. 18, that is, a group forming sequence. FIG. 40 shows an overall relation chart of grouping sequence. This sequence is started upon ending the schedule creation sequence. First, an actual node allocation is done according to the schedule creation result, that is, each service is allocated by a suitable node (S135) and, if node power has to be borrowed from another area, a notification of actual request will be transmitted to the area management node of the other area from which the node power will be borrowed (S136) to obtain the information about the service management node, that is, the surrogate service management node, followed by notifying the service management node, that is, notification of the operation schedule (S137). If borrowing node power from another area, an application module is transmitted to the power lending area, that is, the module is handed over to the surrogate service management node (S138), followed by handing over the application module to common nodes within its own area and/or in the other area from which the node power is borrowed (S139).

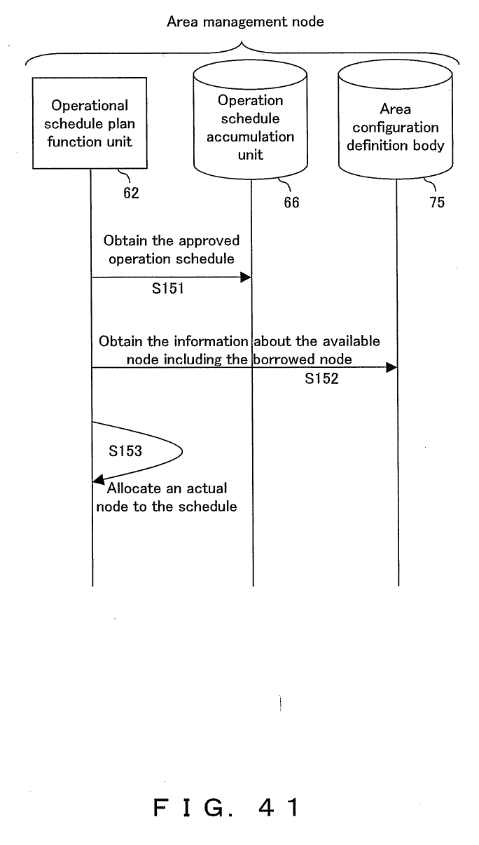

FIG. 41 shows a detail sequence of step S135 shown by FIG. 40, that is, for allocating an actual node. In FIG. 41, the operational schedule plan function unit 62 obtains the operation schedule approved by the operations manager from the operation schedule accumulation unit 66 (S151) and obtains the available node information including the borrowed node from another area from the area configuration definition body 75 (S152) to determine which node to execute what service based on the node power allocation defined by the operation schedule (S153), thus finishing the processing for the actual allocation of the node for the operation schedule.

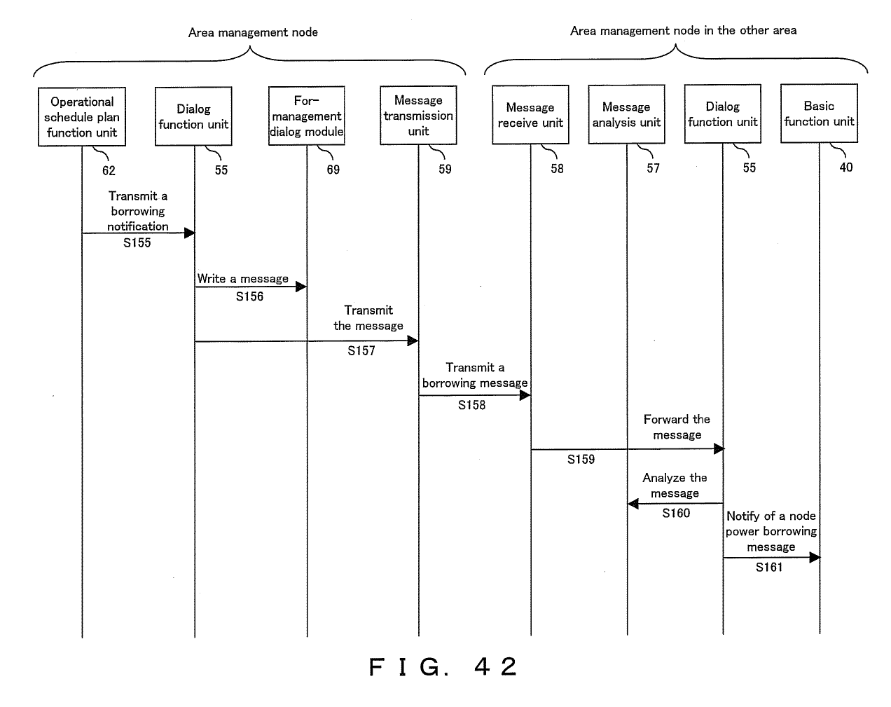

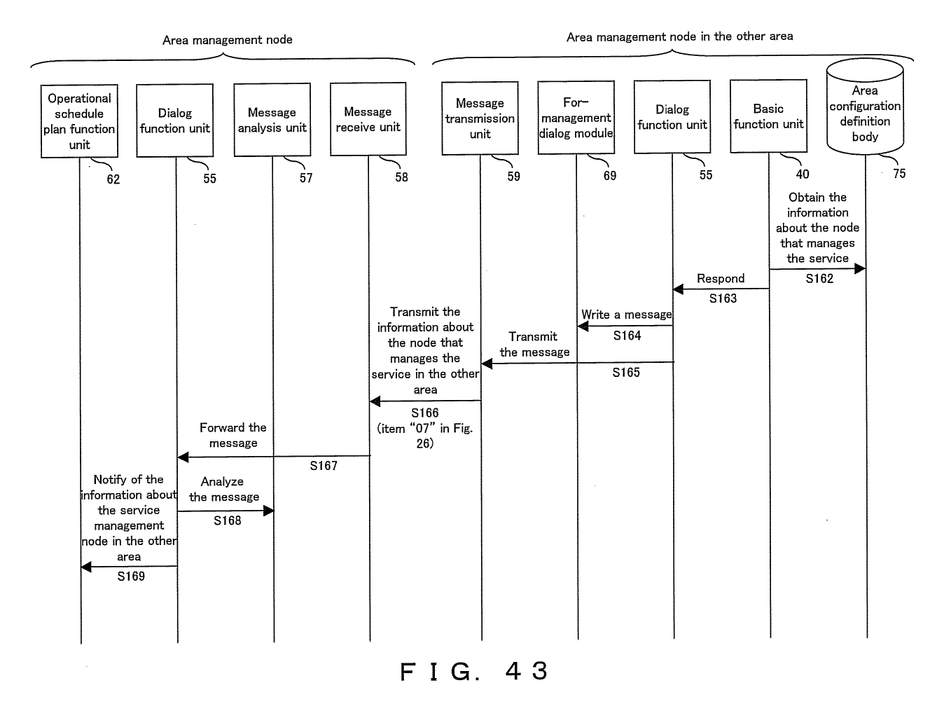

FIGS. 42 and 43 together show a detail sequence of step S136 shown by FIG. 40, that is, for notifying a power lending area. In FIG. 42, at the area management node, through the processing by the operational schedule plan function unit 62, dialog function unit 55, for-management dialog module 69 and message transmission unit 59 in the steps S155 through S158, a “borrowing” message is transmitted to the area management node of the other area for notifying of actually borrowing the node power already requested thereto during the schedule creation.

Over at the area management node of the node power lending area, having received the message, the content of the “borrowing” message is notified to the basic function unit 40 through the processing by the message receive unit 58, dialog function unit 55 and message analysis unit 57 in the steps S159 through S161.

Now turning to FIG. 43, having received the message, the basic function unit 40 obtains from the area configuration definition body 75 the information about the service management node which manages the service (S162), that is, to select the surrogate service management node which manages the service being executed for the power lending area. The selection result is notified to the area management node of the node power borrowing area through the processing by the basic function unit 40, dialog function unit 55, for-management dialog module 69 and message transmission unit 59 in the steps S163 through S166. Here, the content of the notification is the address for the surrogate service management node for managing the service in the other area as shown by the item “07” in FIG. 26.

Back at the area management node in the node power borrowing area, having received the message, the address for the surrogate service management node is notified to the operational schedule plan function unit 62 through the processing by the message receive unit 58, dialog function unit 55 and message analysis unit 57 in the steps S167 through S169.

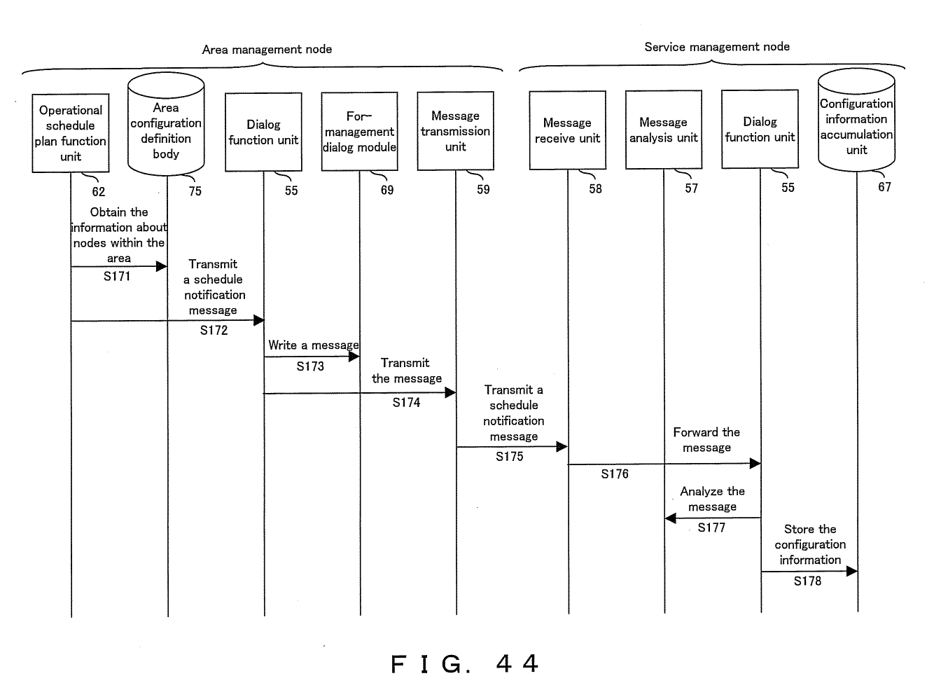

FIG. 44 shows a detail sequence of step S137 shown by FIG. 40, that is, for notifying a service management node. In this sequence, an area management node notifies a service management node for managing a service of an operation schedule for each service, such as the information specifying the application supposedly executed by each node by the day of month or week, et cetera. First, at the area management node, the operational schedule plan function unit 62 obtains the information about the nodes within the area from the area configuration definition body 75 (S171). Then, a schedule notification message is notified to the service management node through the processing by the operational schedule plan function unit 62, dialog function unit 55, for-management dialog module 69 and message transmission unit 59 in the steps S172 through S175.

Over at the service management node, the received message is analyzed through the processing by the message receive unit 58, dialog function unit 55 and message analysis unit 57 in the steps S176 through S178, and the configuration information as the content of the message is stored by the configuration information accumulation unit 67.

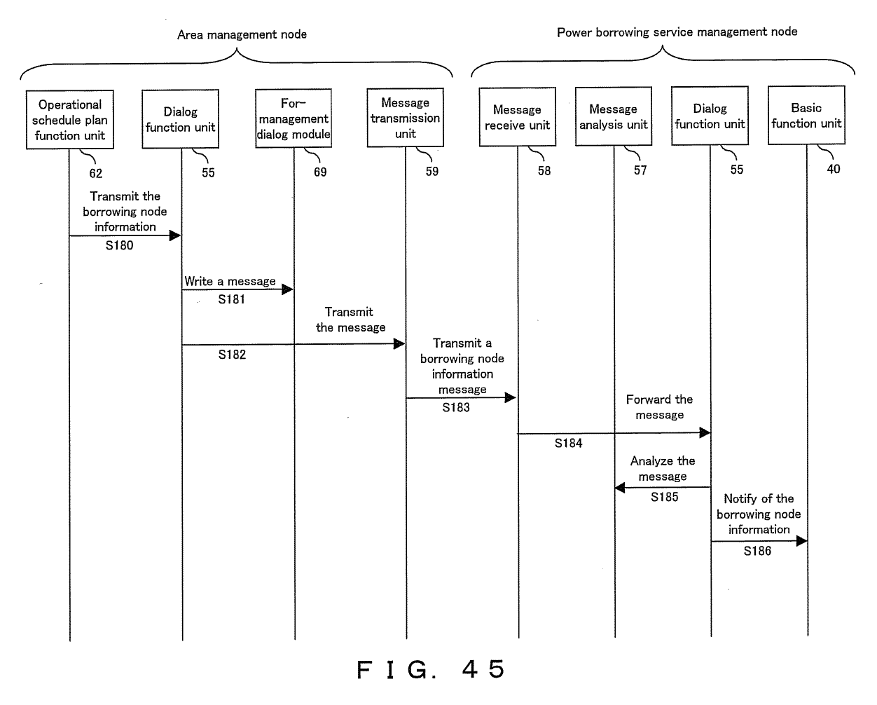

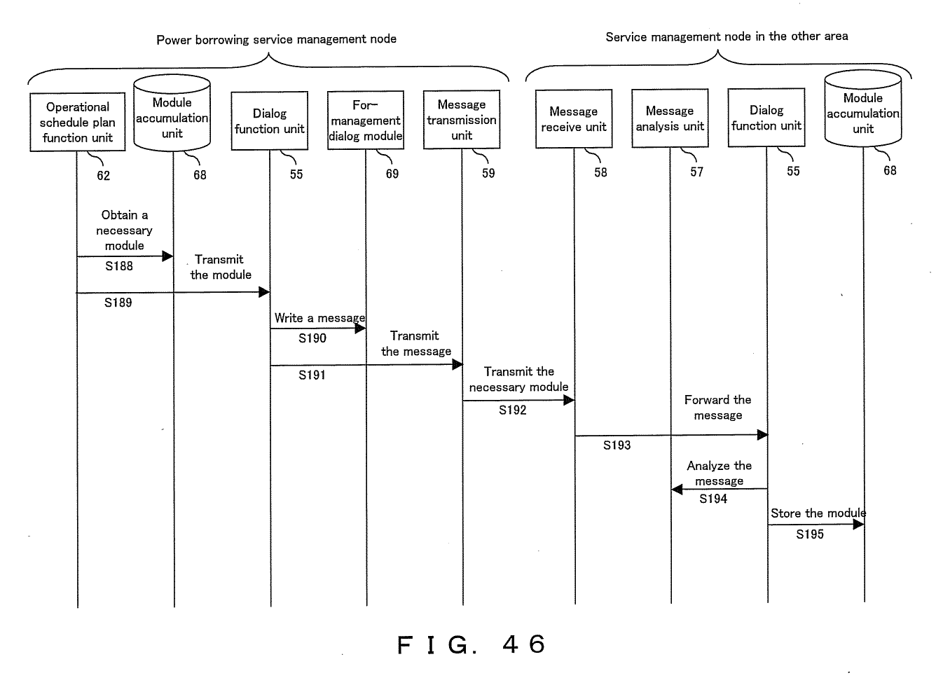

FIGS. 45 and 46 together show a detail sequence of step S138 shown by FIG. 40, that is, for allocating a module to a power lending area. In FIG. 45, at the area management node of the node power borrowing area, a borrowing node information message, that is, a message containing the address for the surrogate service management node which manages the service in the other area, is transmitted to the service management node of the power borrowing area through the processing by the operational schedule plan function unit 62, dialog function unit 55, for-management dialog module 69 and message transmission unit 59 in the steps S180 through S183.

At the service management node of the power borrowing area, the information about the borrowing node is notified to the basic function unit 40 through the processings by the message receive unit 58, dialog function unit 55 and message analysis unit 57 in the steps S184 through S186.

Turning to FIG. 46, at the service management node of the power borrowing area, the operational schedule plan function unit 62 obtains a module necessary for executing an application from the module accumulation unit 68 (S188). And the module necessary for executing the service is transmitted to the surrogate service management node through the processing by the operational schedule plan function unit 62, dialog function unit 55, for-management dialog module 69 and message transmission unit 59 in the steps S189 through S192.

At the surrogate service management node, i.e., that of the other area, the transmitted module is stored in the module accumulation unit 68 through the processing by the message receive unit 58, dialog function unit 55 and message analysis unit 57 in the steps S193 through S195.

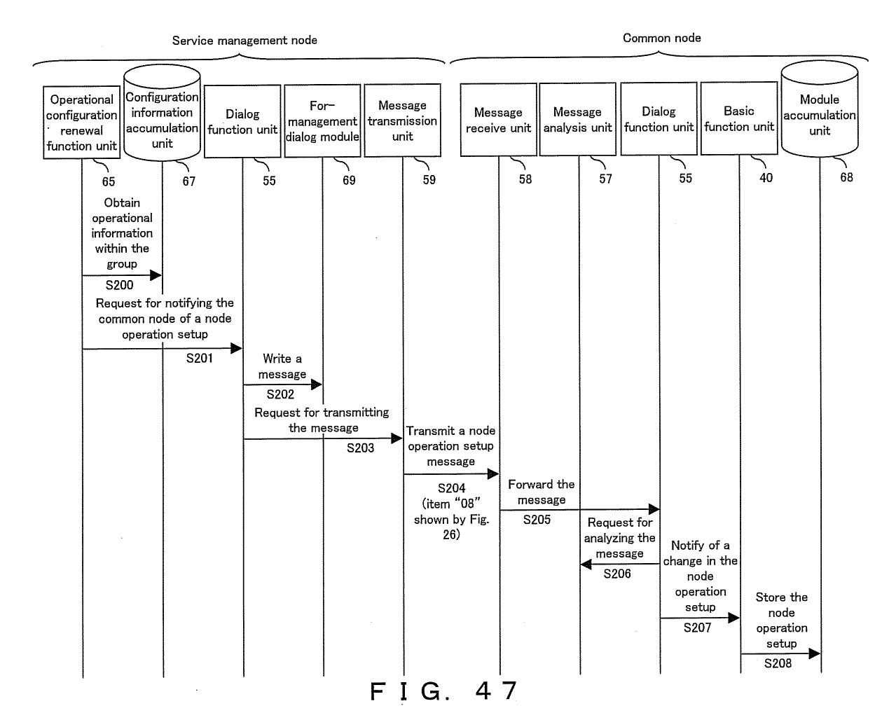

FIGS. 47 through 49 together show a detail sequence of step S139 shown by FIG. 40, that is, for allocating a module to a common node. In FIG. 47, at the service management node, operational configuration renewal function unit 65 obtains the operational information within the group from the configuration information accumulation unit 67 (S200). And a node operation setup message is sent to the common nodes through the processing by the operational configuration renewal function unit 65, dialog function unit 55, for-management dialog module 69 and message transmission unit 59 in the steps S201 through S204. The content of the node operation setup message are the pieces of setup information relating to execution of the service as shown by the item “08” in FIG. 26.

Having received the message at the common nodes, the node operation setup information contained by the message is stored in the respective operational setup definition body 52 through the processing by the message receive unit 58, dialog function unit 55, message analysis unit 57 and basic function unit 40 in the steps S205 through S208. Here, the content of the node operation setup information of course corresponds to the node power allocated to the common nodes and the unit of application by the area management node as described above, while the actual allocation for a request from the client at the time of executing an application will be conducted by a known technique such as round robin scheduling with weight, and therefore it is not necessarily be corresponding to allocating the node power.

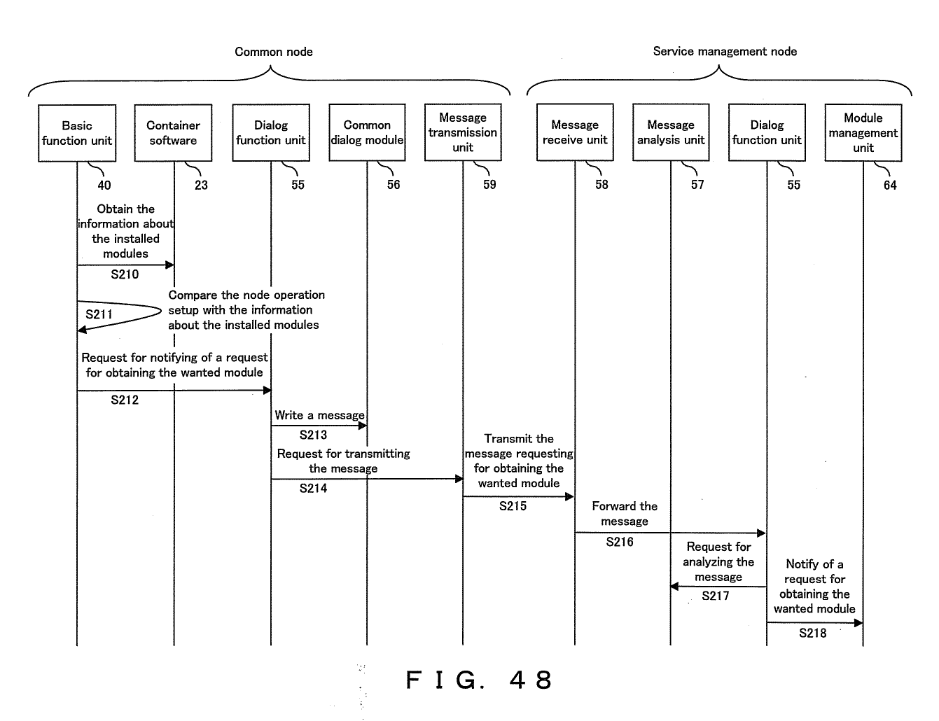

Turning to FIG. 48, at a common node, the basic function unit 40 obtains the information about the installed module from the container software 23 (S210), compares the node operation setup information with the information about the installed module to judge whether or not there is a shortage of module (S211), and, if there is a shortage, then transmit a message to the service management node requesting for obtaining the wanted module through the processing by the basic function unit 40, dialog function unit 55, common dialog module 56 and message transmission unit 59 in the steps S212 through S215.

Having received the message at the service management node, the content of the message is analyzed and a request for obtaining the wanted module is notified to the module management unit 64 through the processing by the message receive unit 58, dialog function unit 55 and message analysis unit 57 in the steps S216 through S218.

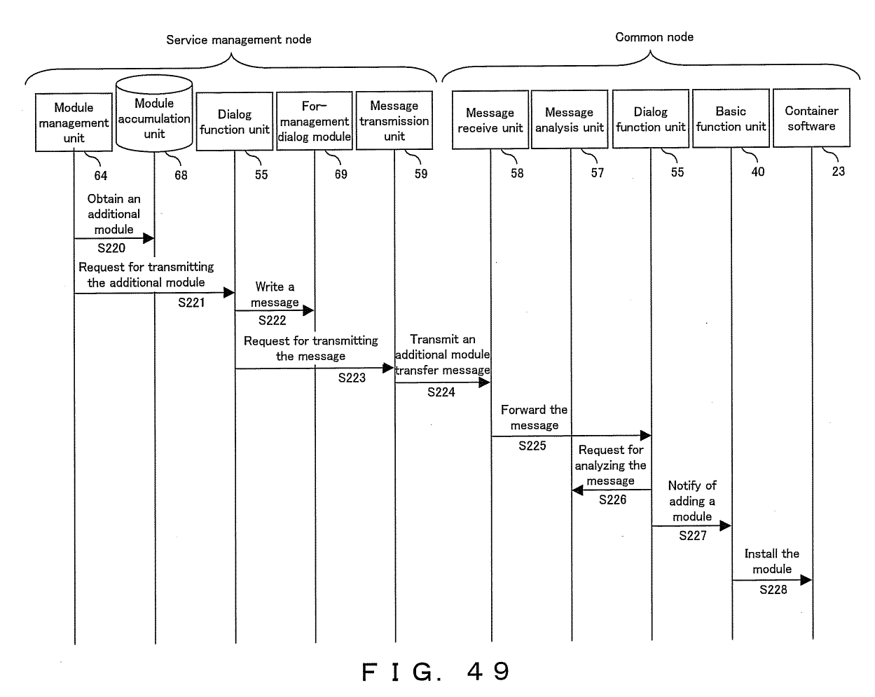

Now turning to FIG. 49, at the service management node, the module management unit 64 obtains an additional module from the module accumulation unit 68 (S220). And an additional module transfer message is sent to the common nodes through the processing by the module management unit 64, dialog function unit 55, for-management dialog module 69 and message transmission unit 59 in the steps S221 through S224.

At the common node, having received the additional module transfer message, the transferred additional module is installed in the container software 23 through the processing by the message receive unit 58, dialog function unit 55, message analysis unit 57 and basic function unit 40 in the steps S225 through S228.

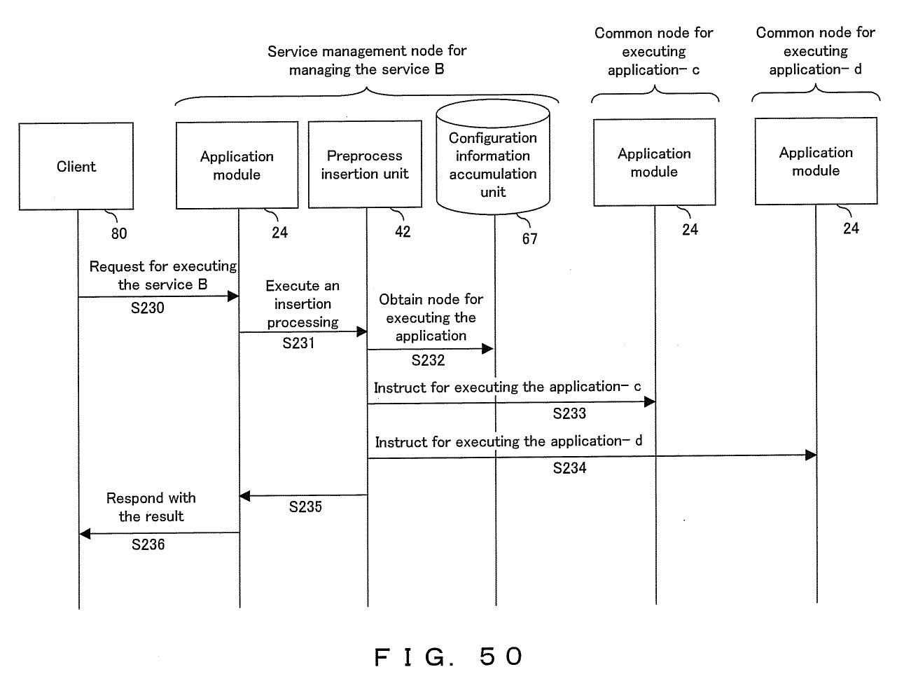

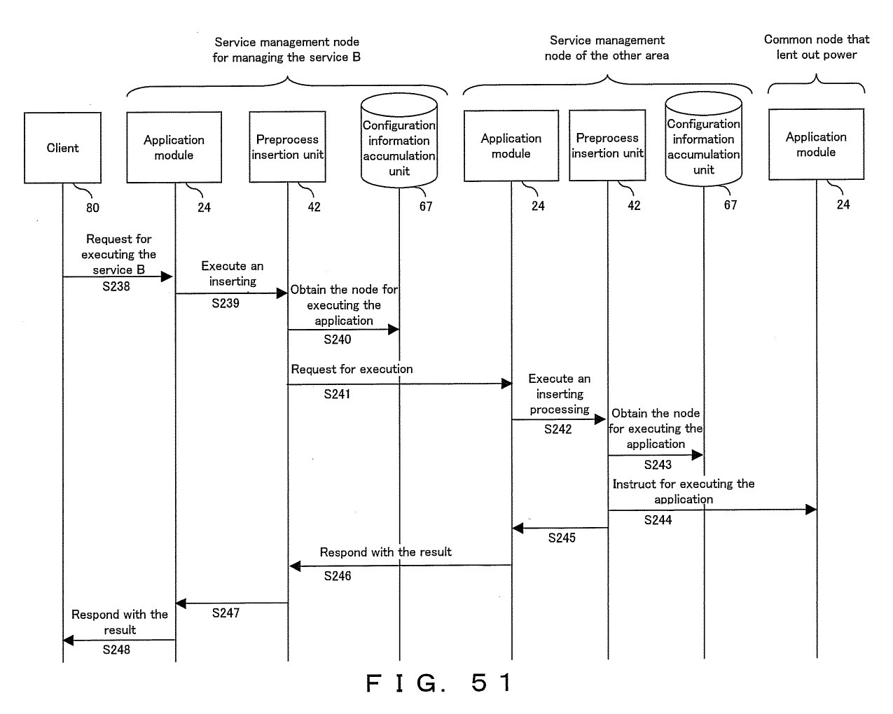

FIGS. 50 and 51 together show a detail sequence for executing a service, that is, application by a common node. FIG. 50 is a service execution sequence performed by a common node applied to the case in which a service management for managing one area, that is, actually one service and common nodes for executing respective applications constituting the service all exist in the aforementioned one area.

In FIG. 50, as a client 80 instructs the application module 24 to execute the service B for example (S230), the application module 24 instructs the preprocess insertion unit 42 to execute an insertion processing (S231), the preprocess insertion unit 42 obtains a suitable node for executing the application (S232) and, at the same time, instructs an application module 24 within the common node which executes the application-c constituting the service B for example (S233) to execute the application-c, and still at the same time, instructs an application module 24 of the common mode which executes the application-d constituting the service B to execute the application-d (S234). The preprocess insertion unit 42 responds with the execution result by way of the application module 24 (S235) back to the client 80 (S236).

As described above, the present embodiment makes the service management node the interface with the client 80 for the service so that a change of node executing an application constituting the service is transparent to the client 80. Incidentally, while each application constituting the service is generally executed by a common node, if a single application is executed by a plurality of nodes, a request is shared by the relative node powers. For example, if an application-c is executed by a node 1 at 50-point node power and node 2 at 100-point node power, the request will be shared by the ratio of 1 to 2.

Now turning to FIG. 51 which is a detail sequence for a node of another area, that is, a borrowed node, executing an application. In FIG. 51, the sequence is approximately the same as with FIG. 50 except that the service management node of the other area, that is, the surrogate service management node resides between a common node for executing an application and the service management node for managing the service B in the node power borrowing area, and that the preprocess insertion unit 42 of the service management node for managing the service B requests the surrogate service management node for executing the application, and therefore a description of the details will be omitted herein.

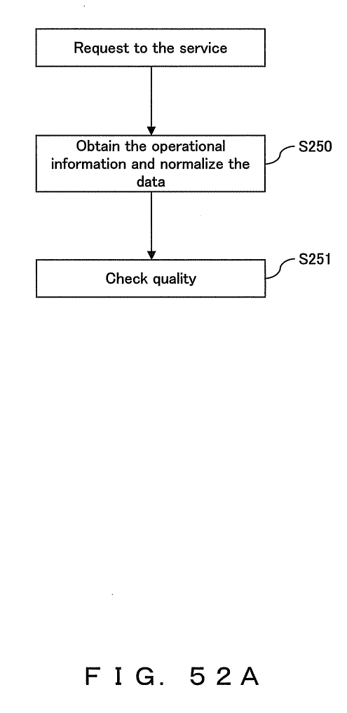

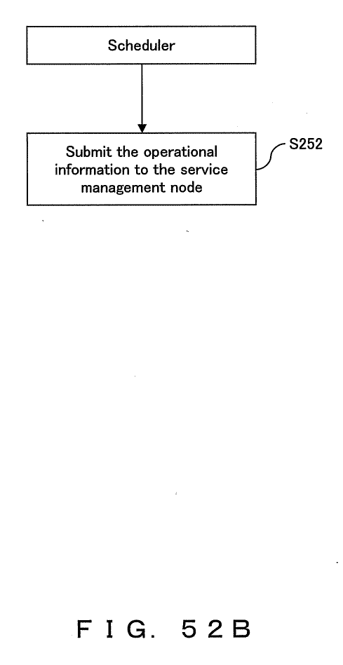

Now the last description of sequence is about the step S4 shown by FIG. 18, that is, a detail sequence of collecting and checking operational information. FIGS. 52A and 52B shows an overall sequence relation chart for collecting and checking operational information. In FIG. 52A, as a client issues a request to the service, the operational information is obtained and the data is normalized (S250). That is, a common node measures a response time, et cetera, as information about the service execution for each request, normalizes the data in accordance with a certain format and stores it in the node, followed by checking the quality (S251).

In FIG. 52B, when the scheduler, that is, the schedule function unit 46, as shown by the logical configuration of the common node in FIG. 11, instructs the service management node to submit the operational information at a certain interval, an operational information submission processing is performed in compliance with the instruction therefrom (S252).

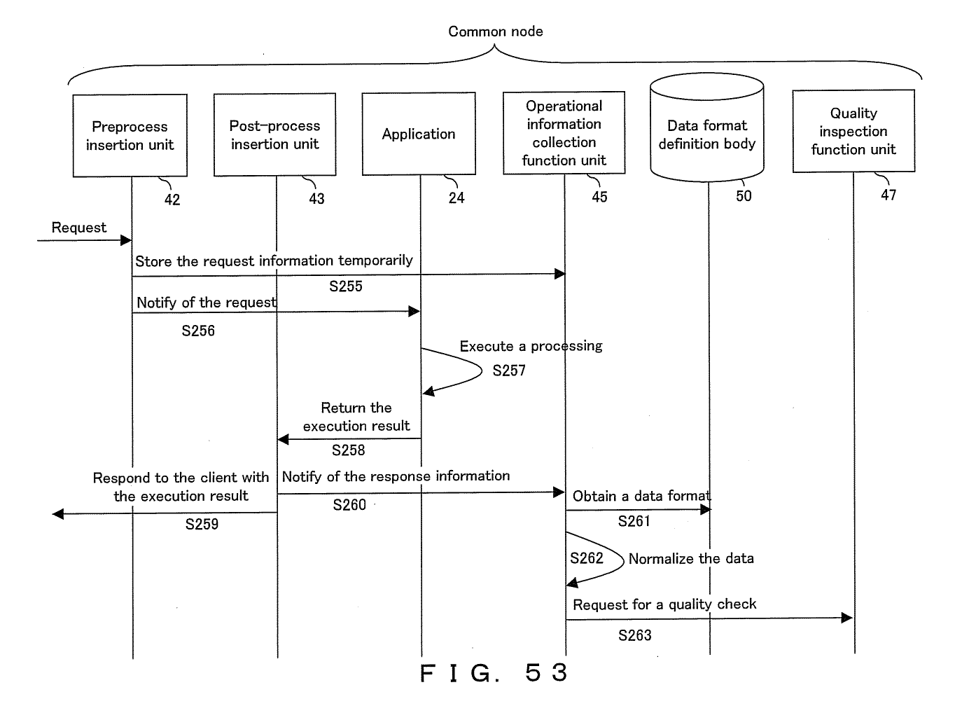

FIG. 53 shows a detail sequence of step S250 shown by FIG. 52A, that is, for obtaining operational information and normalizing the data. The common nodes execute the sequence. First, as a request from the client reached the preprocess insertion unit 42, the request information is temporarily stored in the operational information collection function unit 45 (S255) and at the same time is notified to the application 24 (S256) which execute a processing (S257), followed by responding back to the post-process insertion unit 43 with the execution result (S258), further followed by the post-process insertion unit 43 responding back to the client (S259).

The post-process insertion unit 43 notifies the operational information collection function unit 45 of the response information of the execution result in asynchrony with the above noted response back to the client (S260). The operational information collection function unit 45 obtains the data format from the data format definition body 50 (S261), normalizes the data (S262) and requests the quality inspection function unit 47 for a quality check (S263). In the data normalization, the processing is executed so as to normalize the data such as the information from the requester obtained from the request information and response information, the processing time, et cetera, according to the obtained data format.

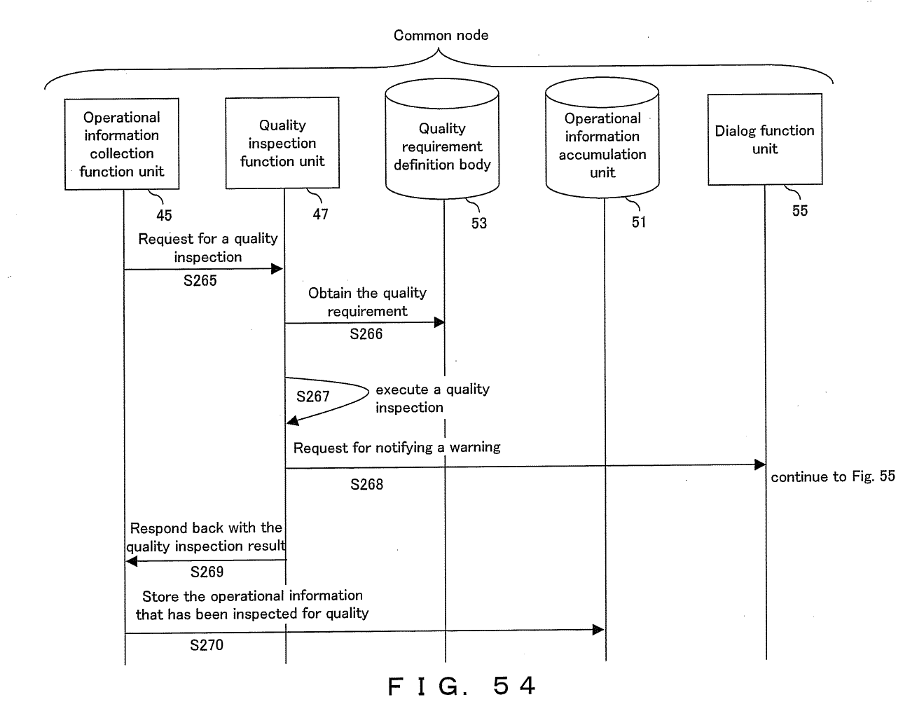

FIGS. 54 through 56 together show a detail sequence for checking quality in step S251 shown by FIG. 52A. The common nodes execute the quality check and notify the service management node of a warning on an as required basis, and further notify the service operations manager of a warning message.

In FIG. 54, at a common node, the operational information collection function unit 45 requests a quality inspection to the quality inspection function unit 47 (S265) which obtains the quality requirement corresponding to the service from the quality requirement definition body 53 (S266), performs a quality check, such as checking whether or not the response time is within a specified time (S267) and, if the quality requirement is not satisfied, requests the dialog function unit 55 for notification in order to notify the service management node of a warning (S268) followed by returning the quality check result to the operational information collection function unit 45 (S269) which in turn has the operational information which has been checked for quality stored by the operational information accumulation unit 51 (S270).

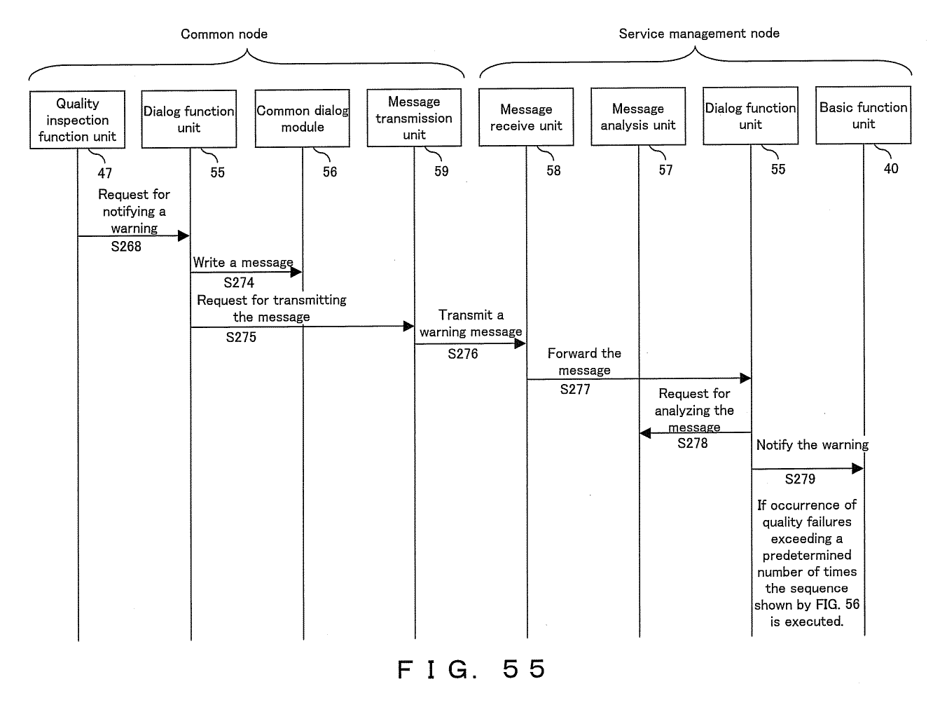

Turning to FIG. 55, the quality inspection function unit 47 of a common node requests the dialog function unit 55 for notifying a warning in step S268 as described above. In response to the request a warning message will be transmitted to the service management node through the processing by the dialog function unit 55, common dialog module 56 and message transmission unit 59 in the steps S274 through S276.

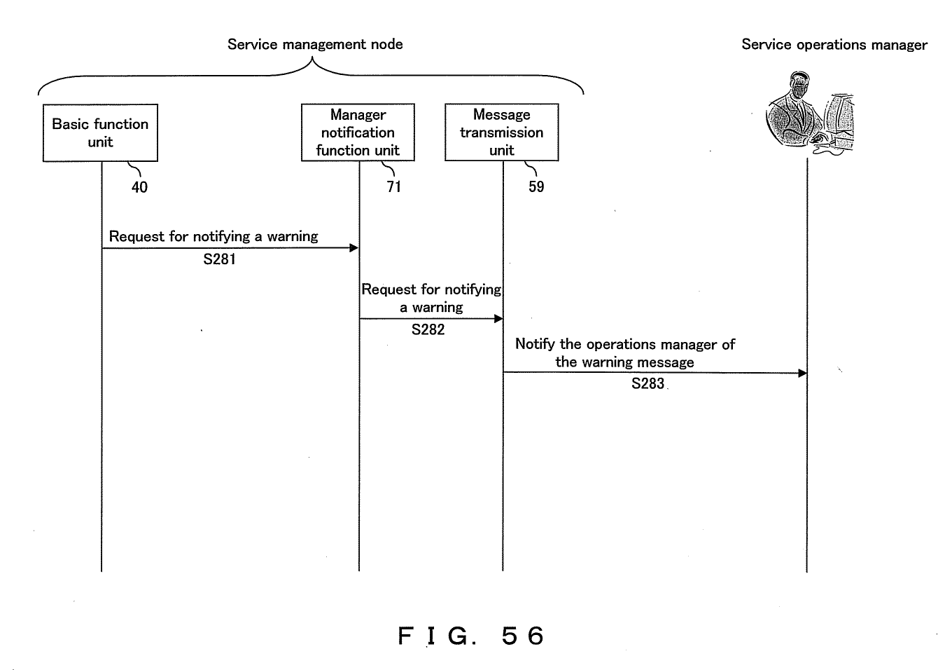

At the service management node, the received message is analyzed through the processing by the message receive unit 58, dialog function unit 55 and message analysis unit 57 in the steps S277 through S279, the content which, that is the warning, is notified to the basic function unit 40. At this point in time the basic function unit 40 comprised by the service management node transmits a warning message to the service operations manager through the sequence shown by FIG. 56. Note that the sequence of FIG. 56 is not necessarily required to be started every time a warning notification is requested in step S282, and may rather be started when quality failures occur in a predetermined number of times for instance.

Now turning to FIG. 56, the basic function unit 40 comprised by the service management node requests the manager notification function unit 71 for notifying a warning (S281) and the warning message will be notified to the service operations manager through the processing by the manager notification function unit 71 and message transmission unit 59 in the steps S282 and S283. Such a notification of warning message enables the service operations manager to devise a response such as revisiting the service schedule in consideration of operational conditions such as the actual service response performance and the number of requests.

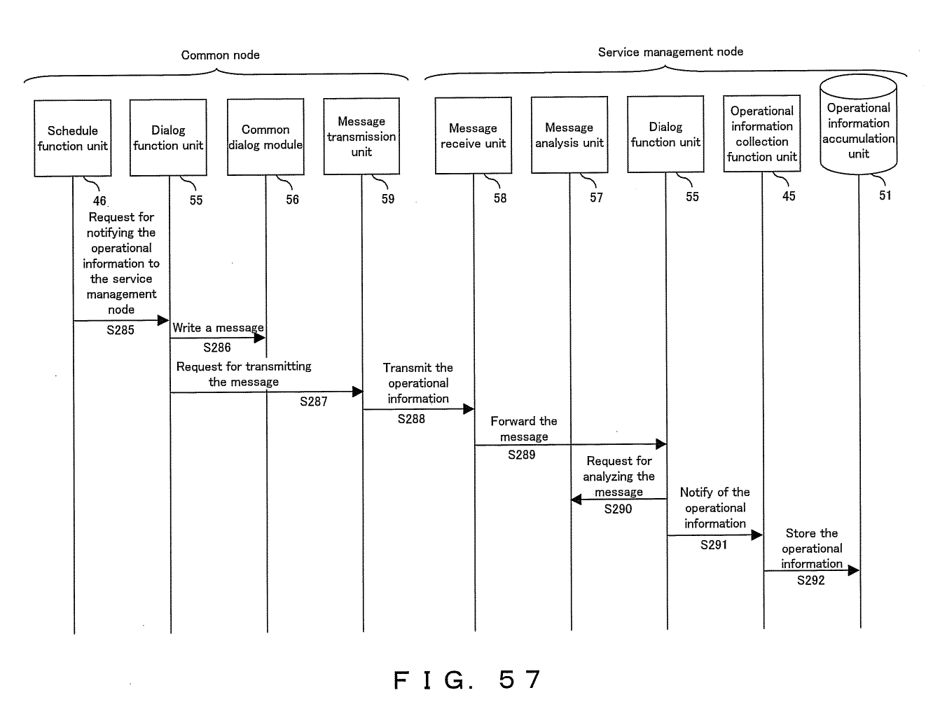

FIG. 57 shows a detail sequence of step S252 shown by FIG. 52B, that is, for submitting operational information to the service management node. In FIG. 57, the schedule function unit 46 comprised by a common node requests the dialog function unit 55 for notifying the retained operational information in a certain interval (S285). In response to the request, the operational information will be transmitted to the service management node through the processing by the dialog function unit 55, common dialog module 56 and message transmission unit 59 in the steps S286 through S288. If the common nodes are under the management of a plurality of service management nodes as described above, the operational information relating to the services (i.e., applications) will be transmitted to the respective service management nodes.

At the service management node, the content of the message is analyzed through the processing by the message receive unit 58, dialog function unit 55, message analysis unit 57 and operational information collection function unit 45 in the steps S289 through S292 and the operational information will be stored in the operational information accumulation unit 51.

The above described is a detailed description of the first embodiment according to the present invention, and the following is a description of a second embodiment according to the present invention. As described above, the second embodiment is configured to carry out a borrowing and lending of node power in the form of requesting an area having a spare node power for borrowing node power byway of the root management node so that the root management node introduces an area capable of lending node power corresponding to a state of a spare node power of each area if the node power of the own area is in shortage when carrying out a planned operation schedule. Note that the configuration of the root management node is the same as that of the root management node described in association with FIG. 13.

FIG. 58 describes a node power lending-out system across areas according to the second embodiment. Comparing FIG. 58 with FIG. 10 of the first embodiment, an area management node 32a intending to borrow node power requests a root management node 31 for lending out the node power, in lieu of the area management node 32a negotiating directly with the area management node 32b for a borrowing and lending of the node power, so that the root management node 31 which manages a state of spare node power in each area introduces, to the area management node 32a, an area capable of lending the node power in the second embodiment.

That is, the second embodiment is configured in such a manner that the area management node 32 of each area registers a state of spare node power with the root management node 31 at the time of a group forming following an operation schedule planning described for FIG. 17 for example, so that the root management node 31 then centrally manages a state of spare node power of each area. Compared with the root management node 31 having the basic role of managing a network address of the area management node of each area in the first embodiment, the root management node 31, in addition to the role therein, also manages a state of spare node of each area and a state of a borrowing and lending the node power across areas in the second embodiment.

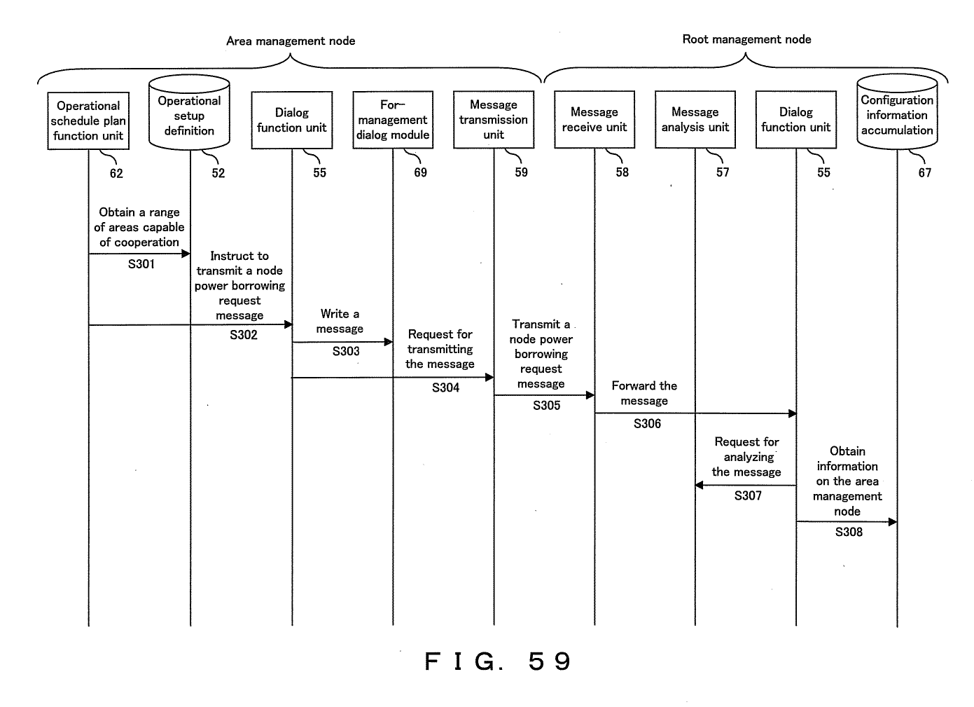

The following description is of the difference in processing with the first embodiment due to the difference of the node power lending method by using FIGS. 59 through 69. Processing other than a borrowing and lending of node power across areas are the same as with the first embodiment and therefore the descriptions are omitted here.

FIGS. 59, 60 and 61 show a detail sequence of requesting other area for borrowing power according to the second embodiment, which respectively correspond to FIGS. 29 through 31 relating to the first embodiment. Referring to FIG. 59 to begin with, the step S301 (also simply “S301” hereinafter) is for the operational schedule plan function unit 62 to obtain a range of areas capable of cooperation as with the S60 shown by FIG. 29 from the operational setup definition body 52. In this case, the assumption is that an area capable of lending node power is statically defined as described above.

Then, a node power borrowing request message is transmitted to the root management node by the processing by the operational schedule plan function unit 62, dialog function unit 55, for-management dialog module 69 and message transmission unit 59 in the steps S302 through S305. In the first embodiment, an area management node acquisition message is transmitted from the area management node to the root management node in the step S64 and only an address of the area management node of other area is inquired, whereas in the second embodiment, indicating a borrowing-desired node power makes a request for a list of areas meeting the condition.

At the root management node, the received message is analyzed by the processing by the message receive unit 58, dialog function unit 55 and message analysis unit 57 in the steps S306 through S308 so that an acquisition of information of the area management node from the configuration information accumulation unit 67, that is, a search for the area management node of an area capable of lending the requested node power is carried out.

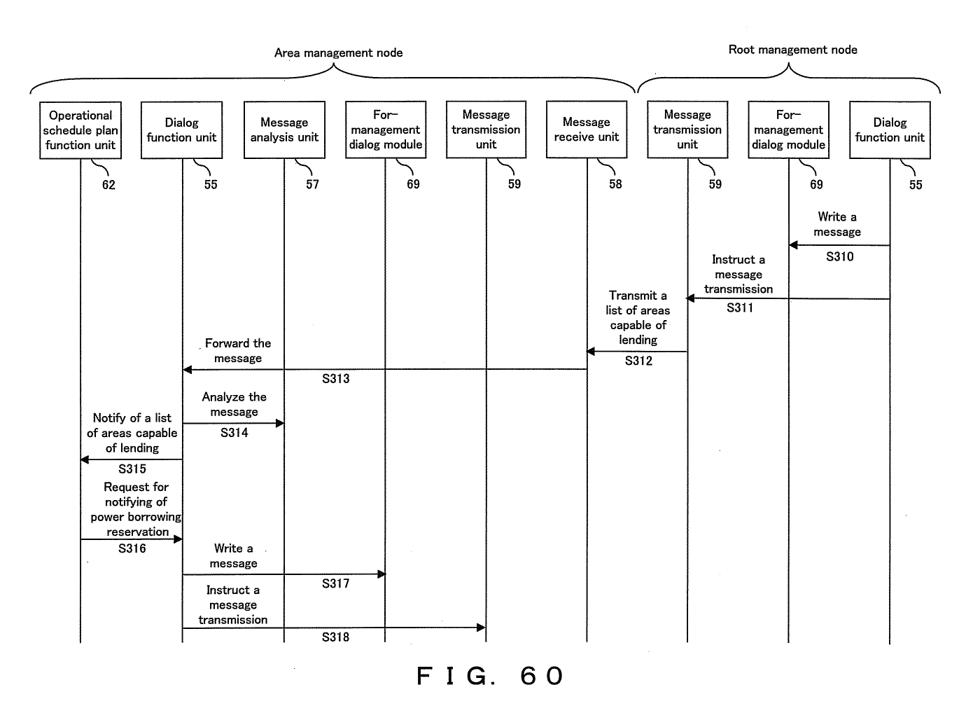

Now turning to FIG. 60, transmission of a message over to an area management node, that is, transmission of a list of areas capable of lending is carried out by the processing by the dialog function unit 55, for-management dialog module 69 and message transmission unit 59 in the steps S310 through S312 at the root management node.

The received message is analyzed and a list of lendable areas is notified to the operational schedule plan function unit 62 by the processing by the message receive unit 58, dialog function unit 55 and message analysis unit 57 in the steps S313 through 315. Then, an instruction for transmitting a message requesting for a node power borrowing reservation is given to the message transmission unit 59 by the processing by the operational schedule plan function unit 62, dialog function unit 55 and for-management dialog module 69 in the steps S316 through S318. That is, an area to which requesting for borrowing node power is selected from the list of areas capable of lending which is obtained from the root management node, a borrowing reservation message is generated and a transmission of the message is instructed to the message transmission unit 59.

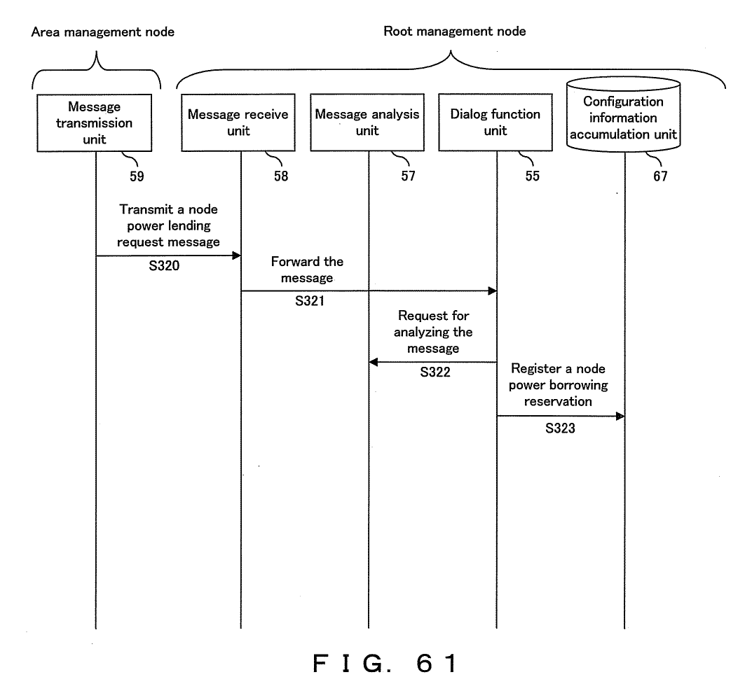

Now turning to FIG. 61, a node power borrowing request message is transmitted from a message transmission unit of the area management node to the root management node in the step S320 so that the received message is analyzed and the node power borrowing reservation is registered in the configuration information accumulation unit 67 by the processing by the message receive unit 58, dialog function unit 55 and message analysis unit 57 in the steps S321 through S323 at the root management node.

The assumption is that the fact of making reservation is not notified to the area management node of an area as the subject of borrowing at this stage. The reason is that a situation such as a double booking does not occur even if a borrowing reservation is not notified to the area management node because the management of a state of spare node power is performed only by the root management node. And an actual borrowing and lending of node power is not carried out at this time, but only a reservation is performed, and the reserved node power in the area is put aside the subject of search for a area capable of lending for node power in the step S308 shown by FIG. 59 in the case of other area requesting for borrowing node power the next time.

As for the node power lend-out availability judgment processing shown by FIG. 32, the second embodiment basically does not require the aforementioned processing due to the fact that a state of spare node power is constantly reported to the root management node.

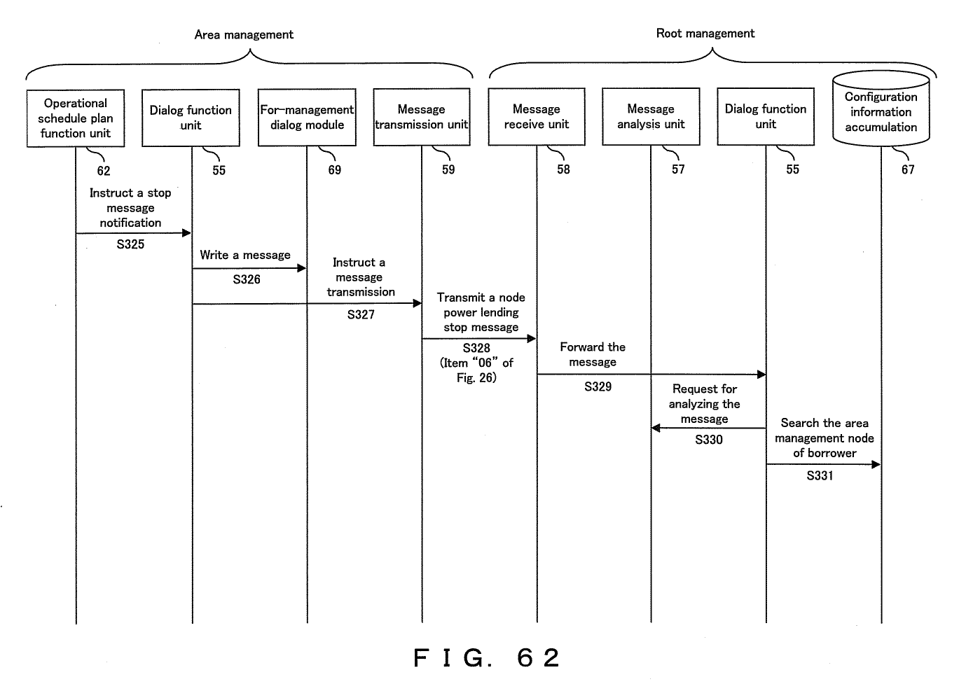

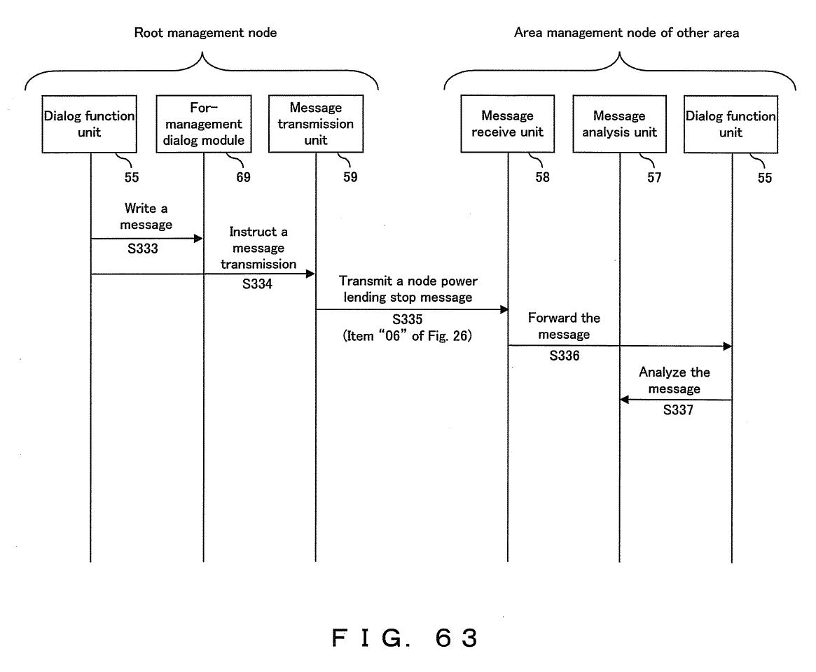

FIGS. 62 and 63 show a detail sequence chart for notifying other node of a node power lending stop according to the second embodiment. This processing corresponds to that of FIG. 33 for the first embodiment. Referring first to FIG. 62, a node power lending stop message is generated and the message is transmitted over to the root management node by the processing by the operational schedule plan function unit 62, dialog function unit 55, for-management dialog module 69 and message transmission unit 59 in the steps S325 through S328 at the area management node wanting to stop lending out the node power. The contents of the node power lending stop message corresponds to the item “06” shown in FIG. 26 as with the step S98 shown by FIG. 33.

The contents of the received message is analyzed and the area management node of a lending-out area as the subject of the node power lending stop message is searched from the configuration information accumulation unit 67 by the processing by the message receive unit 58, dialog function unit 55 and message analysis unit 57 in the steps S329 through S331 at the root management node.

Then turning to FIG. 63, a node power lending stop message is generated and the message is transmitted to the area management node of other area as the subject of notifying of the lending stop by the processing by the dialog function unit 55, for-management dialog module 69 and message transmission unit 59 in the steps S329 through S331 at the root management node. The contents of the message are also the same as the item “06” shown in FIG. 26.

The message is analyzed by the processing by the message receive unit 58, dialog function unit 55 and message analysis unit 57 in the steps S336 and S337 at the area management node in the other area receiving the aforementioned message, and the area management node which receives the node power lending stop notification starts a schedule planning sequence. As such, the second embodiment is configured to notify of also a node power lending stop by way of the root management node.

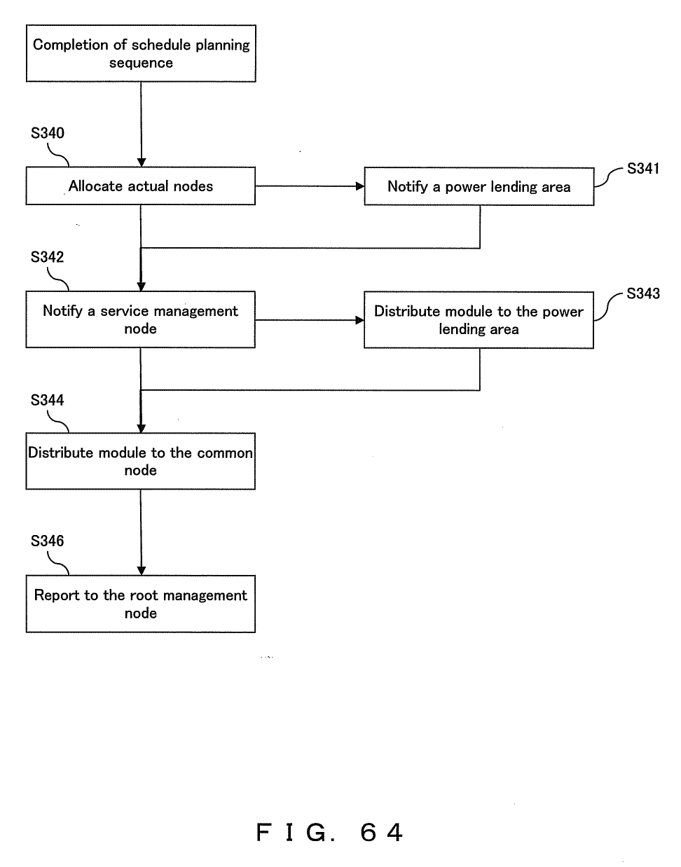

FIG. 64 shows an overall relation chart of grouping sequence according to the second embodiment. This relation chart corresponds to FIG. 40 associated with the first embodiment. Referring to FIG. 64, the processing in the steps S340 through S344 completes the processing up to distributing modules to the common nodes as in the case of FIG. 40, with the second embodiment adding the ensuing processing in the S346, that is, the processing of reporting to the root management node. In other words, the second embodiment is configured in such a manner that a state of spare node power in each area is reported to the root management node at the time of finishing a group forming so that the state of the spares is centrally managed by the root management node which then updates the state of spare node power of each area which is retained by the configuration information accumulation unit 67.

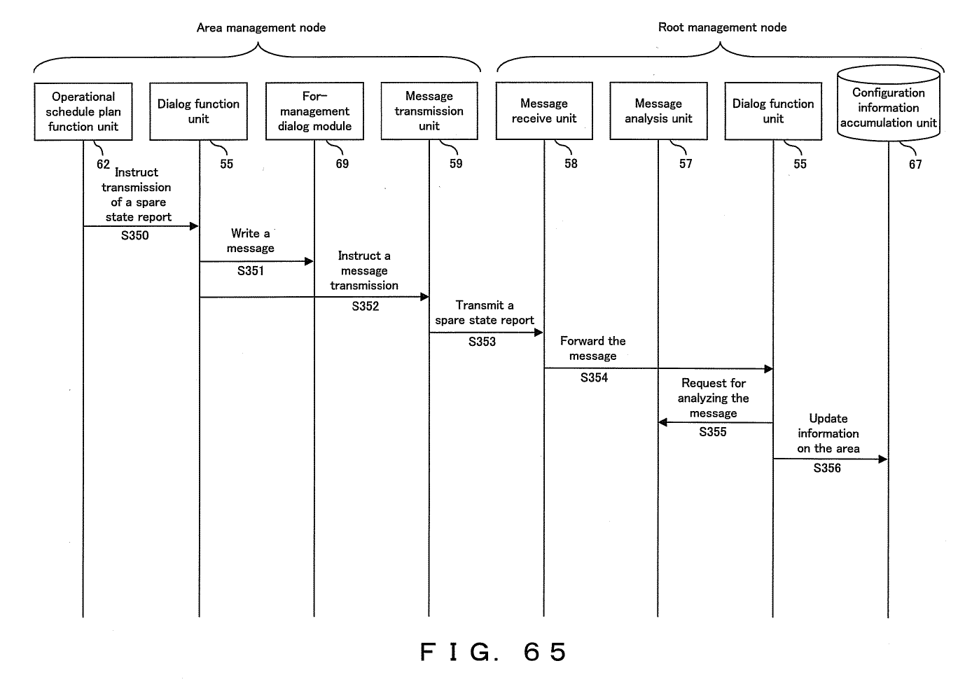

FIG. 65 shows a detail sequence chart for notifying a root management node of a state of spare node power relating to the step S346 shown by FIG. 64. Referring to FIG. 65, a message for reporting a state of spare node power is generated and the message is transmitted over to the root management node by the processing by the operational schedule plan function unit 62, dialog function unit 55, for-management dialog module 69 and message transmission unit 59 in the steps S350 through S353 over at the area management node.

The received message is analyzed and information on the area, that is, the state of spare node power, retained by the configuration information accumulation unit 67 is updated by the processing by the message receive unit 58, dialog function unit 55 and message analysis unit 57 in the steps S354 through S346 at the root management node.

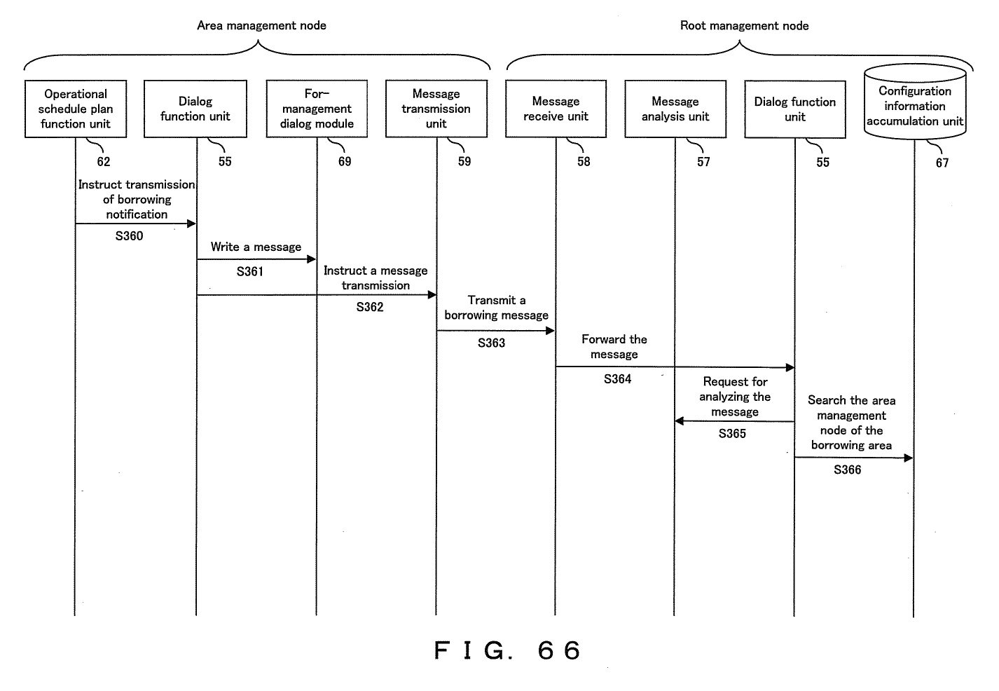

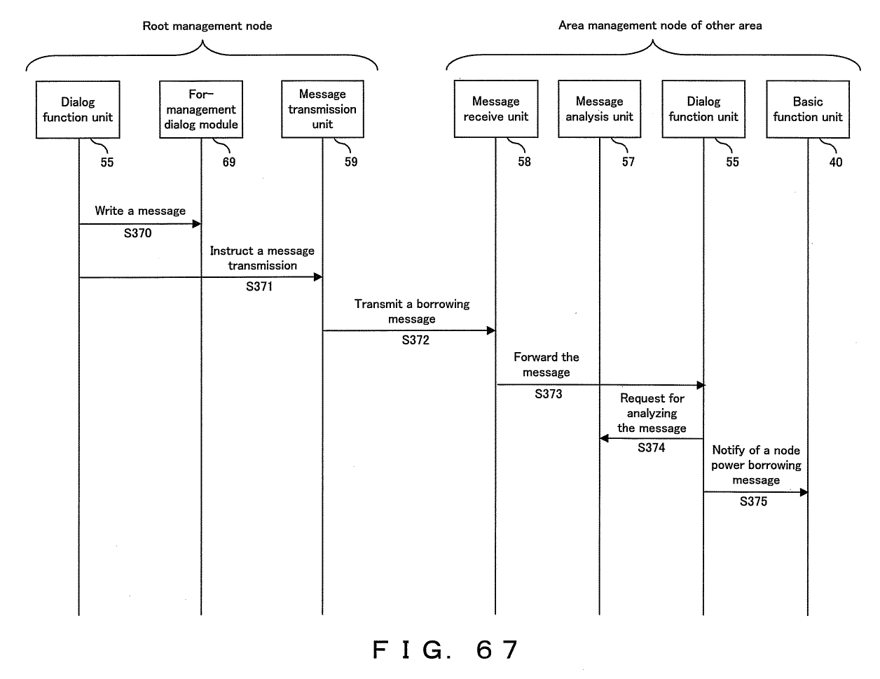

FIGS. 66 and 67 show a detail sequence for notifying a power lending area of a power borrowing message. This sequence corresponds to FIG. 42 associated with the first embodiment, whereas a node power borrowing message is transmitted to the area management node of an area lending the node power in the form of the root management node intervening in the second embodiment, compared to FIG. 42 (i.e., the first embodiment) in which a node power borrowing message is directly transmitted from the area management node of a power borrowing area to the area management node of a power lending area.

Referring to FIGS. 66 and 67, first a node power borrowing message is generated and transmitted over to the root management node by the processing of the operational schedule plan function unit 62, dialog function unit 55, for-management dialog module 69 and message transmission unit 59 in the steps S360 through S363 at the area management node of a node power borrowing area.

At the root management node, the received message is analyzed and the area management node of the node power borrowing area is searched from the configuration information accumulation unit 67 by the processing of the message receive unit 58, dialog function unit 55 and message analysis unit 57 in the steps S364 through S366. A node power borrowing is already reserved as described above, and the assumption is that the reservation status is retained by the configuration information accumulation unit 67 for example.

Referring to FIG. 67, a node power borrowing message is generated and transmitted to the area management node of the node power lending area by the processing of the dialog function unit 55, for-management dialog module 69 and message transmission unit 59 at the root management node in the steps S370 through S372.

Over at the area management node of the node power lending area receiving the aforementioned message, the received message is analyzed and the contents of the node power borrowing message is notified to the basic function unit 40 by the processing of the message receive unit 58, dialog function unit 55 and message analysis unit 57 in the steps S373 through S375.

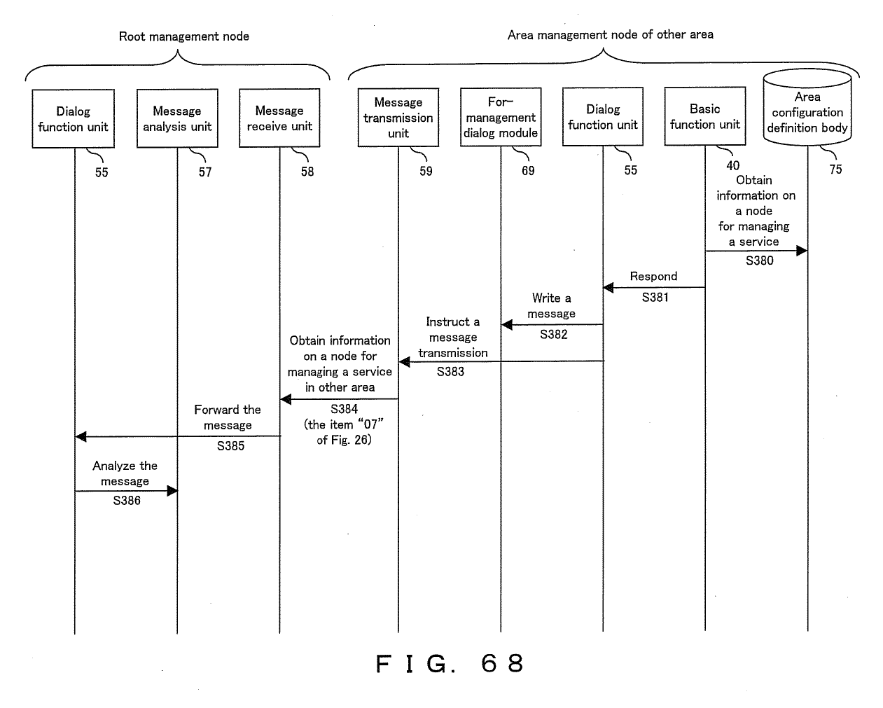

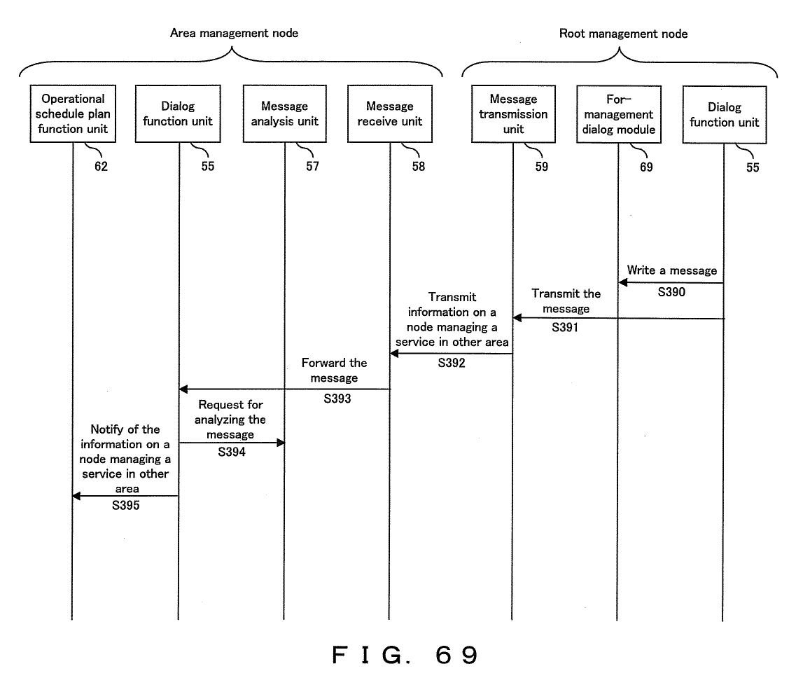

FIGS. 68 and 69 show a detail sequence for the area management node of the node power lending area which has received the node power borrowing message to notify the area management node in the power borrowing area of information on a service management node for managing a sevice carried out by a common node in the power lending area, that is, a surrogate service management node according to the second embodiment. The sequence corresponds to FIG. 43 for the first embodiment.

First in FIG. 68, a node for managing a service, that is, a surrogate service management node, is selected and information such as the address thereof is obtained from the area configuration definition body 75 by the processing of the basic function unit 40 in the step S380 at the area management node of the node power lending area. Then, a message of the information on the service management node is transmitted over to the root management node by the processing of the basic function unit 40, dialog function unit 55, for-management dialog module 69 and message transmission unit 59 in the steps S381 through S384. The contents transmitted by the message correspond to the item “07” of FIG. 26. Over at the root management node, the contents of the message are analyzed by the processing of the message receive unit 58, dialog function unit 55 and message analysis unit 57 in the steps S385 and S386.

And turning to FIG. 69, a transmission message of the information on the surrogate service management node is generated and transmitted to the area management node of the node power borrowing area by the processing of the dialog function unit 55, for-management dialog module 69 and message transmission unit 59 in the steps S390 through S392.

Over at the area management node, having received the message, the received message is analyzed and the information on the surrogate service management node is notified to the operational schedule plan function unit 62 by the processing of the message receive unit 58, dialog function unit 55 and message analysis unit 57 in the steps S393 through S395.

As described thus far, the second embodiment is configured in such manner that the area management node of a node power borrowing area transmits a node power borrowing message to the area management node of a node power lending area by way of the root management node, the area management node, having received the aforementioned message, selects a surrogate service management node and transmits the information to the area management node of the node power borrowing area by way of the root management node; and that the ensuing processing such as a preparation required for an actual service implementation and a report of information on the service execution, et cetera, is carried out directly between the service management node of the node power borrowing area and the service management node of the node power lending area, that is, the surrogate service management node, without an intervention of the root management node as with the first embodiment.

For example, the processing such as a notification to the service management node and a distribution of a module for service implementation described for FIGS. 44 through 49 are all carried out between the aforementioned two areas directly without an intervention of the root management node as with the first embodiment. The reason is that the root management node is disposed only for centrally managing a state of spare node power and a basic intervention to a borrowing and lending of node power so as to prevent a possible problem such as an intervention of the root management node becoming a performance bottle neck when a transferred data volume increases such as distributing modules. Furthermore, except that the root management node carries out a basic intervention in a borrowing and lending of node power, the processing in the second embodiment is the same as that in the first embodiment, and therefore all the descriptions are omitted here.

The resource allocation method and network system according to the present invention have so far been described in detail, whereas the program that is executed by each node for accomplishing the resource allocation method is of course possible to be executed by a common computer.

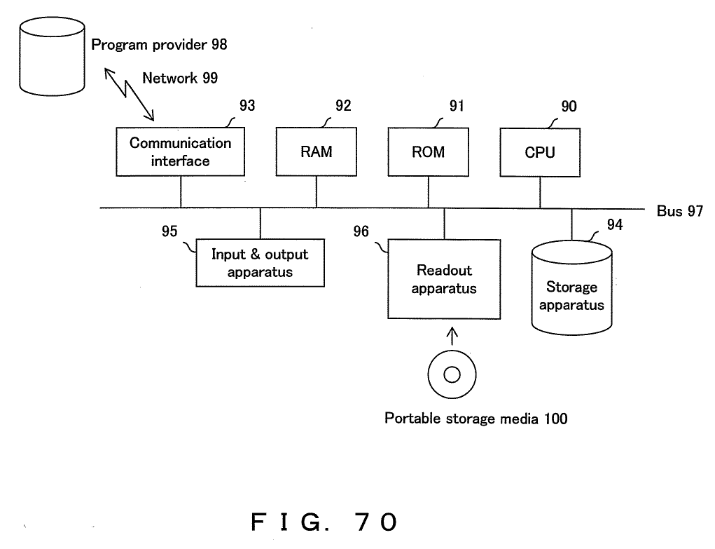

FIG. 70 is a structural block diagram of such a computer, that is, of the hardware environment.

In FIG. 70, the computer system comprises a central processing unit (CPU) 90, a read only memory (ROM) 91, a random access memory (RAM) 92, a communication interface 93, a storage apparatus 94, an input & output apparatus 95, a portable storage media readout apparatus 96 and a bus 97 for connecting the above mentioned components.

The storage apparatus 94, comprehending various forms of storage apparatuses such as hard disk, magnetic disk, et cetera, or a ROM 91, stores a program described as the sequences shown by FIGS. 18 through 69, et cetera, so that the CPU 90 executing such a program makes it possible to accomplish a repetition of sequence for borrowing a node resource from another area when there is a shortage thereof within its own area, creating a service operation schedule, forming a group, collecting operational information, et cetera, put forth by the present embodiment.

It is possible for the CPU 90 to execute such a program which can be stored in the storage apparatus 94 for example from a program provider 98 by way of a network 99 and the communication interface 93, or stored in a marketed and distributed portable storage media 100 and set in the readout apparatus 96. The portable storage media 100 can use various forms of storage media such as CD-ROM, flexible disk, optical disk, magneto optical disk, DVD, et cetera, and an autonomous resource allocation, et cetera, across the network area according to the present embodiment becomes possible when the program stored by these storage media is read out by the readout apparatus 96.

As described in detail above, it is possible to provide a service in response to changes of condition, such as request, while maintaining a specified quality by repeating the three sequences, i.e., collecting operational information relating to the service within the system, creating operation schedule and forming node group for each service, in the form of the nodes autonomously cooperating with one another according to the present embodiment.

Also, an autonomous collection and analysis of the operational information within a system makes it possible to suppress a necessary external management cost to a minimum. Furthermore, an existing node can be retrofitted with the function of the present invention to become a component node of the system, thereby increasing a flexibility of system configuration.

Such autonomous operation is not limited in one area but is possible to apply to node power borrowed from another area, and it is further possible to cancel the lending node power to the other area. Therefore, the quality of service can be maintained in cooperation with another network when there is a shortage of resource available within one area, that is, within a closed network.

What is claimed is:

1. A resource allocation method applied in a network area comprising a plurality of nodes, allocating
a node resource within own network to a service in response to a quality of service to be provided in the network area; and
a node resource borrowed from a network area, which is different from its own network area, to the service when there is a shortage of node resource within the own network area.

2. The resource allocation method applied in a network area according to claim 1, wherein said service is constituted by one or more applications and said node resource is allocated to a specified application among the one or more applications.

3. The resource allocation method applied in a network area according to claim 2, wherein a size of said node resource is defined by node power as processing capability of application and the node resource is allocated to an application by making node power possessed by the node correspond to node power necessary for processing the application.

4. The resource allocation method applied in a network area according to claim 3, wherein said plurality of nodes within said network area are hierarchically configured by
an area management node for managing nodes uniformly within the network area,
a service management node for managing the service to be provided under a supervision of the area management node, and
a common node for executing a processing of application among applications constituting the service under a supervision of the service management node.

5. The resource allocation method applied in a network area according to claim 4, wherein
said service management node calculates node power necessary for processing of application constituting a service to be managed by its own node and creates an operation schedule of the service for a certain period of time, and
said area management node merges service operation schedules created by a plurality of service management nodes to allocate node powers necessary for a plurality of services to be provided within its own area to node resources of common nodes within its own area by the unit of application constituting the service, wherein
node power by the unit of the application is allocated to a node resource of said borrowed common node from another network area if there is a shortage of node power within its own area.

6. The resource allocation method applied in a network area according to claim 5, wherein
said common node reports, to said service management node, a quality as a result of executing application allocated to node power of its own node by said area management node while operating a service operation schedule created for said certain period of time, and
the service management node creates a service operation schedule for a certain period of time next to the certain period thereof based on the report from the common node.

7. The resource allocation method applied in a network area according to claim 6, wherein
a common node in another area which has been allocated by said shortage of node power by the unit of application reports, to a service management node which manages its own node within its own area, a quality as a result of executing an application allocated to node power of its own node, and
the service management node relays the quality report as a result of executing the application to said service management node which has created the service operation schedule.

8. The resource allocation method applied in a network area according to claim 6, wherein
said common node normalizes said result of executing said application in compliance with a request for service to inspect a quality of the execution result.

9. The resource allocation method applied in a network area according to claim 5, wherein
one or more common nodes which has/have been allocated by an application constituting said service and a service management node which has created an operation schedule for the service form one group.

10. The resource allocation method applied in a network area according to claim 9, wherein sequences are autonomously repeated for
creating a service operation schedule by said service management node;
merging service operation schedules and forming a group through allocating node power necessary for the service to a common node by the unit of application by an area management node; and
executing application and reporting a result of execution to a service management node by a common node.

11. The resource allocation method applied in a network area according to claim 5, wherein
said common node reports, to said service management node, a quality as a result of executing an application allocated to node power of its own node by said area management node while operating a service operation schedule created for said certain period of time, and
the service management node recreates an operation schedule for the service when a quality of service constituted by the application exceeds a specified value in a predetermined number of times based on reports from the common node.

12. The resource allocation method applied in a network area according to claim 5, wherein
said service management node hands a module necessary for executing an application over to a common node to which the said area management node has allocated node power by the unit of application.

13. The resource allocation method applied in a network area according to claim 5, wherein
said service management node hands a module necessary for executing an application over to a common node existing in said different area to which the said area management node has allocated node power by the unit of application by way of a service management node which manages the common node allocated by the application in the different area.

14. The resource allocation method applied in a network area according to claim 5, wherein, having received a request from an area management node of a network area in which there is a shortage of said node power for borrowing node power,
said area management node for managing said different network area
judges a surplus or shortage of node power within its own area for satisfying a quality of service in correspondence with a service operation schedule based on a calculation result of node power necessary for each service to be provided by its own area,
calculates a lendable node power if there is a surplus in node power, and
notifies the area management node which has requested for borrowing node power of the lendable node power.

15. The resource allocation method applied in a network area according to claim 5, further comprising
a root management node for managing said area management nodes for all of a plurality of network areas, wherein
an area management node for each of the plurality of network areas reports a state of the spare to the root management node when there is spare node power within its own area as a result of allocating node power required for said service to a node resource of a common node within the own area, and
the root management node searches an area capable of lending node power and intervenes in a borrowing and lending of node power in response to a node power borrowing request from an area management node of a network area having a shortage of node power corresponding to the report result.

16. The resource allocation method applied in a network area according to claim 5, wherein
said service management node calculates node power necessary for each application constituting a service based on an actual quality of service achieved throughout an operation of operation schedule created in the past by using node power which has been allocated to each application constituting the service when creating said service operation schedule.

17. A resource allocation method applied in a network area comprising a plurality of nodes, allocating
a node resource within its own network to a service in response to a quality of service to be provided in the network area;
a node resource to the service by canceling a lent out node resource to a network area different from its own network area when there is a shortage of node resource within its own network area; and
a node resource borrowed from a network area, which is different from its own network area, to the service when there is still a shortage of node resource.

18. A storage medium for storing a program to make a computer execute for allocating a resource in a network area comprising a plurality of nodes, wherein the program comprises the sequences of allocating
a node resource within its own network to a service in response to a quality of service to be provided in the network area;
a node resource to the service by canceling a lent out node resource to a network area different from its own network area when there is a shortage of node resource within its own network area; and
a node resource borrowed from a network area, which is different from its own network area, to the service when there is still a shortage of node resource.

19. A storage medium for storing a program to make a computer execute for allocating a resource in a network area comprising a plurality of nodes, wherein the program comprises the sequences of allocating
a node resource within its own network to a service in response to a quality of service to be provided in the network area; and
a node resource borrowed from a network area, which is different from its own network area, to the service when there is a shortage of node resource within its own network area.

20. A network system corresponding to one area comprising a plurality of nodes, comprising:
a common node for executing an application constituting a service to be provided in the network area; and
an area management node for allocating a node resource within its own network to a service in response to a quality of service to be provided in the network area, a node resource to the service by canceling a lent out node resource to a network area different from its own network area when there is a shortage of node resource within its own network area, and a node resource borrowed from a network area, which is different from its own network area, to the service when there is still a shortage of node resource.
